(19) United States
(12) Patent Application Publication
(10) Pub. No.: US 2025/0255766 A1
(43) Pub. Date: Aug. 14, 2025

(54) SPINAL SURGERY PATIENT POSITIONER

(71) Applicant: Bartram Innovations, LLC, Atlanta, GA (US)

(72) Inventors: Daniel Hal Silcox, III, Atlanta, GA (US); D. Hal Silcox, IV, Atlanta, GA (US)

(21) Appl. No.: 19/048,951

(22) Filed: Feb. 9, 2025

Related U.S. Application Data
(60) Provisional application No. 63/552,021, filed on Feb. 9, 2024.

(51) Int. Cl. A61G 13/12

(52) U.S. Cl. CPC A61G 13/1265

(57) ABSTRACT

A patient positioning system including an active positioner assembly including: a pad; a positioner arm coupled to the pad; and an adjustment hub coupled to the positioner arm and including a lock, the lock configured to lockably maintain a position of the positioner arm with respect to the adjustment hub; and a passive positioner assembly configured to abut the patient opposite the active positioner assembly to securely hold the patient between the passive positioner assembly and the active positioner assembly.

### CROSS-REFERENCE TO RELATED APPLICATIONS

This application claims the benefit of U.S. Provisional Patent Application No. 63/552,021, filed on Feb. 9, 2024, which is incorporated by reference herein in its entirety.

### TECHNICAL FIELD

This disclosure relates to surgical equipment. More specifically, this disclosure relates to patient positioner apparatuses, as well as related systems, and methods for use in spinal surgeries.

### BACKGROUND

Minimally invasive spine fusion surgery (MIS) techniques continue to grow in popularity. LLIF, OLIF, and XLIF have gained significant popularity in recent years. These surgeries typically involve positioning the patient in the right lateral decubitus position, as this position allows for the safest access to the spine with decreased risk of injury to major vascular structures. Additionally, the lateral position aids in gravity-induced retraction of the peritoneal contents. Furthermore, surgeons can utilize a single position to access the anterior and posterior spine without requiring intraoperative repositioning by operating in a lateral position. The described positioning for LLIF is maintained during surgery by taping the patient to the table with an axillary roll and optional bolster under the right flank. However, this traditional method of positioning the patient is not particularly secure, nor does it aid in correcting/reducing spinal deformities or fractures before making an incision or instrumenting the spine.

### SUMMARY

It is to be understood that this summary is not an extensive overview of the disclosure. This summary is exemplary and not restrictive, and it is intended neither to identify key or critical elements of the disclosure nor delineate the scope thereof. The sole purpose of this summary is to explain and exemplify certain concepts of the disclosure as an introduction to the following complete and extensive detailed description.

Disclosed is a patient positioning apparatus comprising: a pad; a positioner arm coupled to the pad; and an adjustment hub coupled to the positioner arm and configured to dynamically receive, while loaded, an adjustment input during a surgery, the adjustment hub further comprising a lock, the lock configured to lockably maintain a position of the positioning pad.

In other embodiments, disclosed is a patient positioning system comprising: an active positioner assembly comprising: a pad; a positioner arm coupled to the pad; and an adjustment hub coupled to the positioner arm and comprising a lock, the lock configured to lockably maintain a position of the positioner arm with respect to the adjustment hub; and a passive positioner assembly configured to abut the patient opposite the active positioner assembly to securely hold the patient between the passive positioner assembly and the active positioner assembly.

In yet other embodiments, disclosed is a method for preoperative and intraoperative positioning of a patient, the method comprising: adjusting at least one passive positioner assembly to contact the patient, the patient lying on a table; and dynamically adjusting at least one active positioner assembly to securely stabilize the patient with respect to the table.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1 is a top view of a patient positioned on a table using a known method of positioning.

FIG. 2 is a top view of a patient positioned on a table using a patient positioning system, in accordance with one aspect of the present disclosure.

FIG. 3A is a front perspective view of a positioning pad of the patient positioning system of FIG. 2.

FIG. 3B is a rear perspective view of the positioning pad of FIG. 3A.

FIG. 4A is a partial detailed side view of the positioner arm of FIG. 5, taken from detail 4A of FIG. 5.

FIG. 4B is a front perspective view of a socket of the patient positioning system of FIG. 2.

FIG. 4C is a side view of the socket of FIG. 4B.

FIG. 5 is a side view of a positioner arm of the patient positioning apparatus of FIG. 6, in accordance with one aspect of the disclosure.

FIG. 6 is a side view of a patient positioning apparatus of the patient positioning system of FIG. 2, in accordance with one aspect of the present disclosure.

FIG. 7 is a top perspective view of a patient positioning apparatus, in accordance with one aspect of the present disclosure.

FIG. 8 is a partial perspective view of an adjustment hub and a positioner arm of a patient positioning apparatus, in accordance with another aspect of the present disclosure.

FIG. 9 is a side perspective view of the positioner arm of FIG. 8.

FIG. 10 is a cross-sectional view of an adjustment hub of a patient positioning apparatus, in accordance with another aspect of the present disclosure.

FIG. 11 is a partial top view of the adjustment hub of FIG. 10 taken along line 11-11 of

FIG. 10, where portions of the adjustment hub are removed in order to illustrate the internal mechanisms.

FIG. 12 is a partial top view of an adjustment hub and a positioner arm of a patient positioning apparatus, in accordance with another aspect of the present disclosure, where portions of the adjustment hub are removed in order to better show a gear train mechanism thereof.

FIG. 13 is a partial cross-sectional view of an adjustment hub and a positioner arm of a patient positioning apparatus, in accordance with another aspect of the present disclosure.

FIG. 14 is a side view or end view of an outer miter gear of the patient positioning apparatus of FIG. 13.

FIG. 15 is a top view of a miter wheel assembly of the patient positioning apparatus of FIG. 13.

FIG. 16 is an end view of the positioner arm of FIG. 13.

FIG. 17 is a cross-sectional view of the positioner arm of FIG. 16 taken along line 17-17 in FIG. 16.

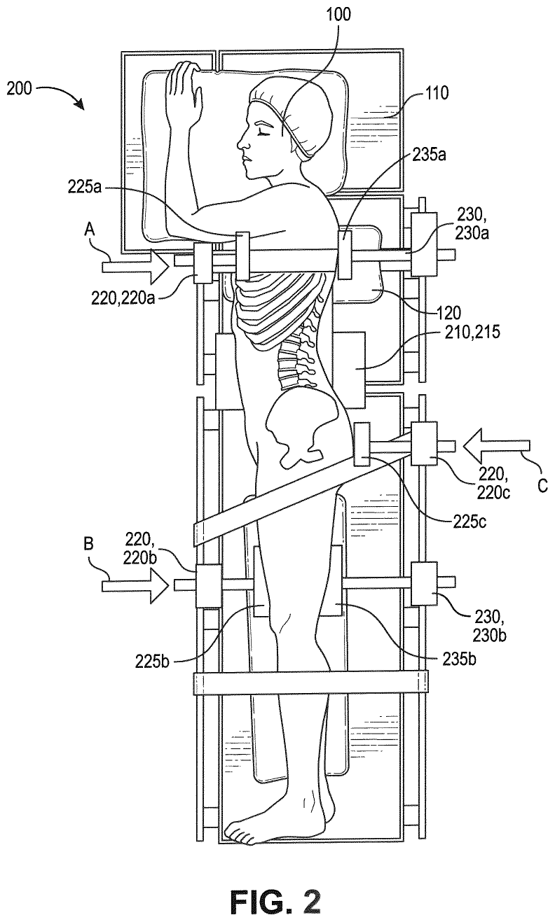

FIG. 18 is a side perspective view of a bladder of the patient positioning system of FIG. 2, in accordance with another aspect of the present disclosure.

FIG. 19 is a cross-sectional view of the bladder of FIG. 18 taken along line 19-19 in FIG. 18.

FIG. 20 is a top view of a patient positioned on the table using a patient positioning system, in accordance with another aspect of the present disclosure.

FIG. 21 is either the active positioner assembly or the passive positioner assembly of the patient positioning system of FIG. 20 adjustably mounted to the table.

FIG. 22 is a top front perspective view of the patient positioned on the table using the patient positioning system of FIG. 20.

FIG. 23 is a top rear perspective view of the patient positioned on the table using the patient positioning system of FIG. 20.

FIG. 24 is a rear view of an active positioner assembly, in accordance with another aspect of the present disclosure.

FIG. 25 is a top view of the active positioner assembly of FIG. 24.

FIG. 26 is a side view of a positioner arm, a lock, and a ratchet of the active positioner assembly of FIG. 24 showing the lock engaged with the positioner arm.

FIG. 27 is a side view of the positioner arm of FIG. 26 showing the lock disengaged from the positioner arm.

FIG. 28 is a perspective view of the active positioner assembly of FIG. 24 showing an upright in a raised position with respect to a clamp of the active positioner assembly.

FIG. 29 is a top perspective view of the active positioner assembly of FIG. 24 showing an upright in a lowered position with respect to the clamp of the active positioner assembly.

FIG. 30A is a top view of the active positioner assembly of FIG. 24.

FIG. 30B is a detail top view of the active positioner assembly of FIG. 24 taken from detail 30B of FIG. 30A showing a drive element engaged with the positioner arm. FIG. 31A is a top view of the active positioner assembly of FIG. 24.

FIG. 31B is a detail top view of the active positioner assembly of FIG. 24 taken from detail 31B of FIG. 31A showing a drive element disengaged from the positioner arm.

FIG. 32 is a side view of the active positioner assembly of FIG. 24.

FIG. 33 is a sectional side view of the positioner arm and pad of the active positioner assembly of FIG. 24.

FIG. 34 is a sectional side view of a clamp of the active positioner assembly of FIG. 24.

FIG. 35 is a partial sectional side view of the active positioner assembly of FIG. 24.

FIG. 36 is an exploded side perspective view of an adjustment hub of the active positioner assembly of FIG. 24.

FIG. 37 is an exploded top perspective view of the clamp of the active positioner assembly of FIG. 24.

FIG. 38 is an exploded top perspective view of the positioner arm and pad of the active positioner assembly of FIG. 24.

FIG. 39 is an exploded top perspective view of the active positioner assembly of FIG. 24.

FIG. 40 is a top view of a patient positioned on a table using the patient positioning system comprising the active positioner assembly of FIG. 24 showing the patient positioning system before adjustment.

FIG. 41 is a top view of the patient positioned on the table using the patient positioning system comprising the active positioner assembly of FIG. 24 showing the patient positioning system after adjustment.

FIG. 42 is a side view of a passive positioner assembly, in accordance with another aspect of the disclosure.

FIG. 43 is an exploded top rear perspective view of the passive positioner assembly of FIG. 42.

FIG. 44 is an exploded top rear perspective view of an adjustment hub of the passive positioner assembly of FIG. 42.

FIG. 45 is a sectional side view of a positioner arm and a pad of the passive positioner assembly of FIG. 42.

FIG. 46 is a perspective view of a patient positioned on a table using the patient positioning system comprising the passive positioner assembly of FIG. 42 showing the patient positioning system before adjustment.

FIG. 47 is a perspective view of the patient positioned on the table using the patient positioning system comprising the passive positioner assembly of FIG. 42 showing the patient positioning system after adjustment.

FIG. 48 is a rear view of the passive positioner assembly of FIG. 42.

FIG. 49 is a top view of the passive positioner assembly of FIG. 42.

FIG. 50 is a side view of the active positioner assembly of FIG. 24.

FIG. 51 is a composite x-ray image of a lateral lumbar fusion.

FIG. 52 is an x-ray image showing standing lateral (baseline lordosis).

FIG. 53 is an x-ray image showing right lateral decubitus position.

FIG. 54 is an x-ray image showing right lateral decubitus position with forced lordosis utilizing aspects of the present disclosure.

FIGS. 55-68 are x-ray images from a test case utilizing aspects of the present disclosure.

FIG. 69 is an image of a test subject positioned on a table.

FIG. 70 is an image of the test subject of FIG. 69 positioned in forced lordosis utilizing aspects of the present disclosure.

FIG. 71 is a table displaying data from tests conducted.

FIG. 72 is a boxplot of the data shown in FIG. 71.

FIG. 73 is a table showing results from Shapiro-Wilk test for each data set.

FIG. 74 is a table showing the results of each paired test.

FIG. 75 is a table showing the results of each Cohen's D test.

FIGS. 76-80 are x-ray images of a case described herein where aspects of the disclosure were employed.

FIGS. 81-86 are x-ray images of another case described herein where aspects of the disclosure were employed.

FIG. 87 is a table of raw data collected in tests described herein.

### DETAILED DESCRIPTION

The present disclosure can be understood more readily by reference to the following detailed description, examples, drawings, and claims, and the previous and following description.

However, before the present devices, systems, and/or methods are disclosed and described, it is to be understood that this disclosure is not limited to the specific devices, systems, and/or methods disclosed unless otherwise specified, and, as such, can, of course, vary. It is also to be understood that the terminology used herein is for the purpose of describing particular aspects only and is not intended to be limiting.

The following description is provided as an enabling teaching of the present devices, systems, and/or methods in its best, currently known aspect. To this end, those skilled in the relevant art will recognize and appreciate that many changes can be made to the various aspects of the present devices, systems, and/or methods described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an” and “the” include plural referents unless the context clearly dictates otherwise. Thus, for example, reference to “an element” can include two or more such elements unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance can or cannot occur, and that the description includes instances where said event or circumstance occurs and instances where it does not.

The word “or” as used herein means any one member of a particular list and also includes any combination of members of that list. Further, one should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect. Disclosed are components that can be used to perform the disclosed methods and systems.

These and other components are disclosed herein, and it is understood that when combinations, subsets, interactions, groups, etc. of these components are disclosed that while specific reference of each various individual and collective combinations and permutations of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific aspect or combination of aspects of the disclosed methods.

Disclosed is a patient positioning system and associated methods, systems, devices, and various apparatus. Example aspects of the patient positioning system can comprise a passive positioner assembly and an active positioner assembly. It would be understood by one of skill in the art that the patient positioning system is described in but a few exemplary embodiments among many. No particular terminology or description should be considered limiting on the disclosure or the scope of any claims issuing therefrom. A patient positioning apparatus or a positioner assembly can be considered “active” if it is configured to dynamically apply a force against a patient at any time during pre-operative, intra-operative, or post-operative conditions, e.g., through mechanical leverage provided by the apparatus or the assembly itself, and can otherwise be considered “passive.”

While the disclosed apparatus, system, and method are described with reference to a patient and a table or similar structure, it is to be understood that the disclosure is not limited to any particular type of patient or table. A person of ordinary skill in the art would readily recognize that the disclosed apparatus, system, and method can be configured for use with any patient, and references to a patient are not intended to render the disclosure indefinite. Likewise, references to attachments, positions, or other features associated with a table are understood to encompass configurations involving any structure or surface that supports the disclosed apparatus, system, or method in relation to a patient. Furthermore, the table or surface is not limited to any specific orientation, and directional terms used herein are provided with respect to the patient for ease of description. Indeed, aspects of the disclosure are inherently capable of securing a patient in position relative to a table even if the table moves or is re-positioned relative to its environment. In addition, a description of a particular feature explicitly associated with a particular reference number (e.g., a clamp 240) can, unless dictated otherwise by the context, properly carry over to a description of a similar feature (generally, any feature having the same name and/or material purpose) explicitly associated with a different reference number (e.g., a clamp 1230), and vice versa.

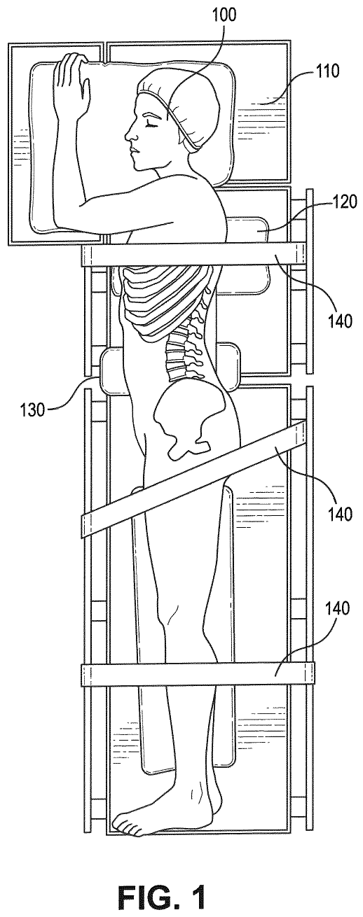

FIG. 1 is a top view of a patient 100 positioned on a table 110 using a known method of positioning. The prior art method of positioning can comprise orienting the patient 100 in a right lateral decubitus position, as shown. An axillary roll 120 can be positioned under the patient's right armpit, and an optional bolster 130 can be positioned under the patient's right flank. The patient 100 can further be taped to the table 110 in the desired position with any suitable medical-grade tape 140.

FIG. 2 is a top view of the patient 100 positioned on the table 110 using a patient positioning system 200, in accordance with one aspect of the present disclosure. The patient positioning system 200 can be used to properly and securely position a patient for surgical procedures, including but not limited to, spinal surgeries. The patient 100 is shown oriented in the right lateral decubitus position. In example aspects, the axillary roll 120 can still be positioned under the patient's right armpit to reduce pressure on the patient's right shoulder. Additionally, the patient positioning system 200 can optionally comprise a bladder 210 that can be positioned under the patient's right flank. The bladder 210 can be an air bladder 215, for example and without limitation, that can be selectively inflated and deflated to a desired volume to suitably support the patient's right flank. In other aspects, the bladder 210 can contain any suitable liquid or gas other than air. The bladder 210 can be used to prevent coronal sag for patients 100 with wider hips. Additionally, if the patient 100 has a known lumbar or thoracolumbar deformity or fraction, the bladder 210 can be positioned at the apex of the known deformity to aid in correcting/reducing the spinal deformities or fractures prior to surgery.

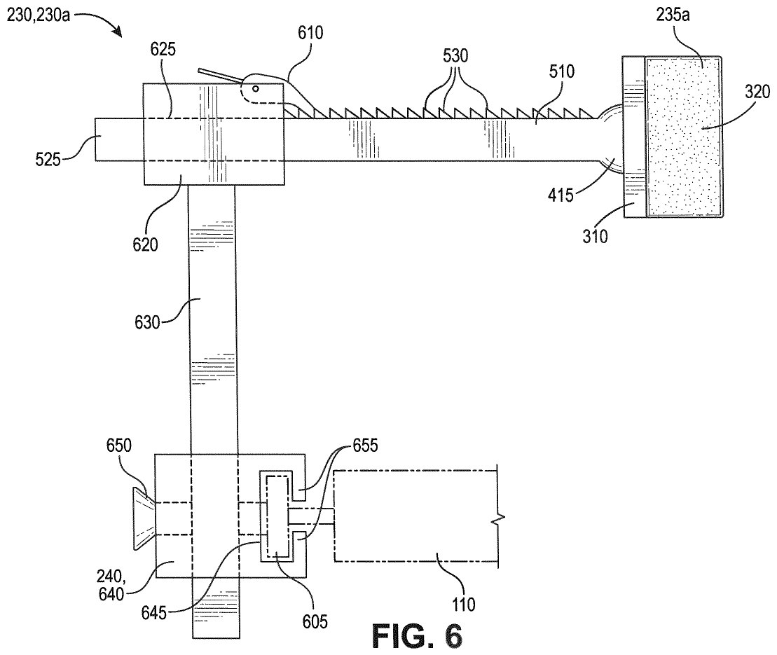

The patient positioning system 200 can further comprise one or more active positioner assemblies 220. In the present aspect, the active positioner assemblies 220 can comprise a sternal active positioner assembly 220a, a thigh active positioner assembly 220b, and a sacral active positioner assembly 220c. The sternal active positioner assembly 220a can be positioned at the anterior (i.e., front) side of the patient 100 and can apply a force against the patient's sternum in a posterior (i.e., rear) direction, as indicated by directional arrow A. The sternal active positioner assembly 220a can comprise a sternal pad 225a abutting the patient's sternum. The sacral active positioner assembly 220c can be positioned at the posterior side of the patient 100 and can apply a force against the patient's sacrum in an anterior direction, as indicated by directional arrow C. The sacral active positioner assembly 220c can comprise a sacral pad 225c abutting the patient's sacrum. The thigh active positioner assembly 220b can be positioned at the anterior side of the patient 100 and can apply a force against the front of the patient's thighs in the posterior direction, as indicated by directional arrow B. The thigh active positioner assembly 220b can comprise a front thigh pad 225b abutting the front side of the patient's thighs. Each of the active positioner assemblies 220 can be secured to the table 110 by a corresponding clamp 240 (shown in FIG. 6) or can be otherwise attached to the table 110.

Example aspects of the patient positioning system 200 can further comprise one or more passive positioner assemblies 230. For example, in the present aspect, the passive positioner assemblies 230 can comprise a sternal passive positioner assembly 230a and a thigh passive positioner assembly 230b. The sternal passive positioner assembly 230a can be positioned at the posterior side of the patient 100. More specifically, the sternal passive positioner assembly 230a can be positioned directly opposite the sternal active positioner assembly 220a. The sternal passive positioner assembly 230a can comprise a back pad 235a abutting the patient's upper back. The thigh passive positioner assembly 230b can also be positioned at the posterior side of the patient 100. More specifically, the thigh passive positioner assembly 230b can also be positioned directly opposite the thigh active positioner assembly 220b. The thigh passive positioner assembly 230b can comprise a rear thigh pad 235b abutting the rear side of the patient's thighs. Each of the passive positioner assemblies 230 can be clamped or otherwise attached to the table 110.

The sternal pad 225a of the sternal active positioner assembly 220a can be selectively adjusted to apply the force in the posterior direction A against the patient's sternum to create a forced innate lordosis curve in the patient's spine. The back pad 235a of the sternal passive positioner assembly 230a can abut the patient's upper back to secure the patient's upper body in the desired position on the table 110. More specifically, the back pad 235a of the sternal passive positioner assembly 230a can be positioned opposite the sternal active positioner assembly 220a. The front thigh pad 225b of the thigh active positioner assembly 220b can be selectively adjusted to apply the force in the posterior direction B against the front side of the patient's thighs to further create the desired forced innate lordosis curve in the patient spine. The rear thigh pad 235b of the thigh passive positioner assembly 230b can abut the rear side of the patient's thighs, opposite the thigh active positioner assembly 220b, to secure the patient's lower body in the desired position on the table 110. More specifically, the rear thigh pad 235b of the thigh passive positioner assembly 230b can be positioned opposite the thigh active positioner assembly 220b. Additionally, the sacral active positioner 220c can also be selectively adjusted to apply the force in the anterior direction C against the patient's sacrum to further create the desired forced innate lordosis curve in the patient's spine. Forcing the patient's spine into the innate lordosis curve during preoperative positioning can decrease the patient's risk of iatrogenic flat back from spinal fusion surgery and can also improve the reduction of sagittal plane spinal deformities and the reduction of spinal fractures.

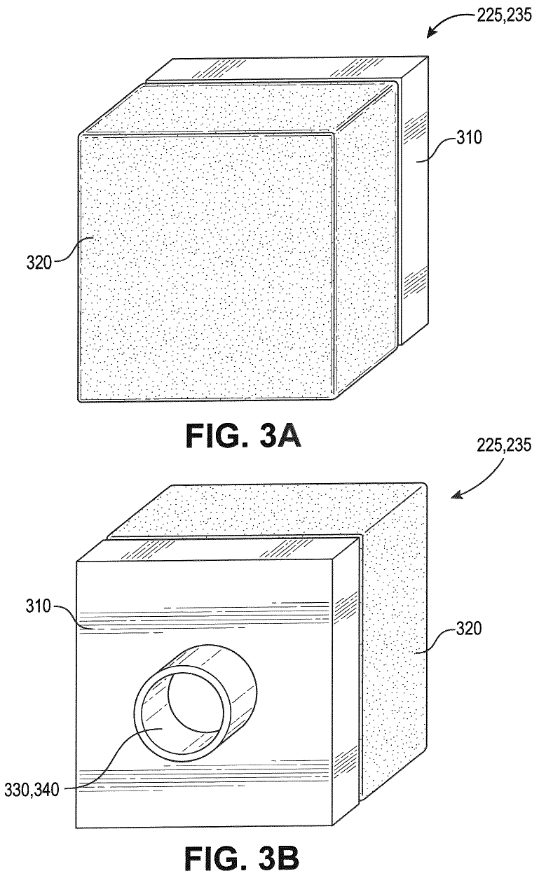

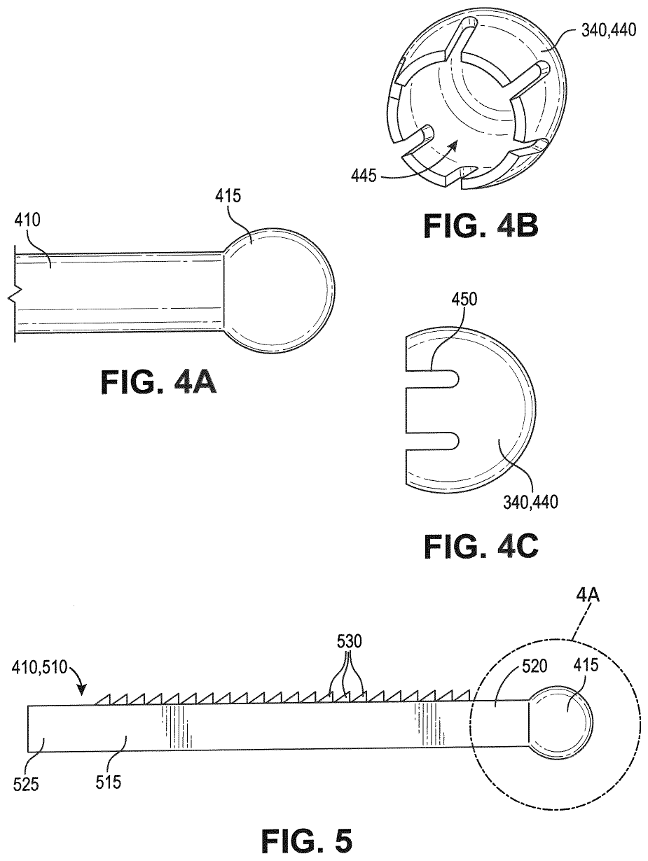

FIG. 3A is a front perspective view and FIG. 3B a rear perspective view of one of the positioning pads 225,235. More specifically, an example aspect of one of the pads 225,235 (e.g., the sternal pad 225a, the back pad 235a, the sacral pad 225c, the front thigh pad 225b, or the rear thigh pad 235b) is shown. In example aspects, the pads 225 of the active positioner assemblies 220 can be substantially the same or similar to the pads 235 of the passive positioner assemblies 230. In other aspects, the pads 225 can be different from the pads 235. According to example aspects, each of the pads 225,235 can comprise a base 310 and a cushioned pad portion 320 attached to the base 310. In example aspects, the base 310 can comprise a substantially rigid or sturdy material such as, for example and without limitation, plastic. In example aspects, the cushioned pad portion 320 can comprise a cushioning material such as, for example and without limitation, a coated foam rubber. In some aspects, the base 310 and the cushioned pad portion 320 can comprise any other suitable material. Additionally, in example aspects, the base 310 can comprise an arm attachment 330 for attaching a positioner rod or positioner runner or positioner arm 410 (shown, e.g., in FIGS. 4A-5) thereto. The arm attachment 330 can comprise a socket 340 in the present aspect. In other aspects, the arm attachment 330 can define any other suitable configuration.

FIGS. 4A, 4B, and 4C illustrate an embodiment of the positioner arm 410 and the socket 340. The socket 340 can be a ball bearing socket 440 in the present aspect and can define a substantially rounded socket cavity 445 for receiving a ball end 415 of the positioner arm 410 and for allowing rotational movement of the ball end 415. In example aspects, the socket 340 and/or the ball end 415 can comprise a substantially rigid or sturdy material such as, for example and without limitation, plastic. Relief notches 450 can be formed at an open front end 455 of the ball bearing socket 440 and can allow the ball bearing socket 440 to flex as the ball end 415 of the positioner arm 410 is pushed through the open front end 455 into the socket cavity 445. The positioner arm 410 can thereby be attached to the base 310 (shown in FIG. 3) of the corresponding pad 225,235 (shown in FIG. 3) via the ball bearing socket 440. The ball end 415 can be integrally formed in the positioner arm 410. The positioner arm 410 can define any suitable cross-sectional shape, including but not limited to, circular or rounded, T-shaped, triangular, rectangular or square, or the like.

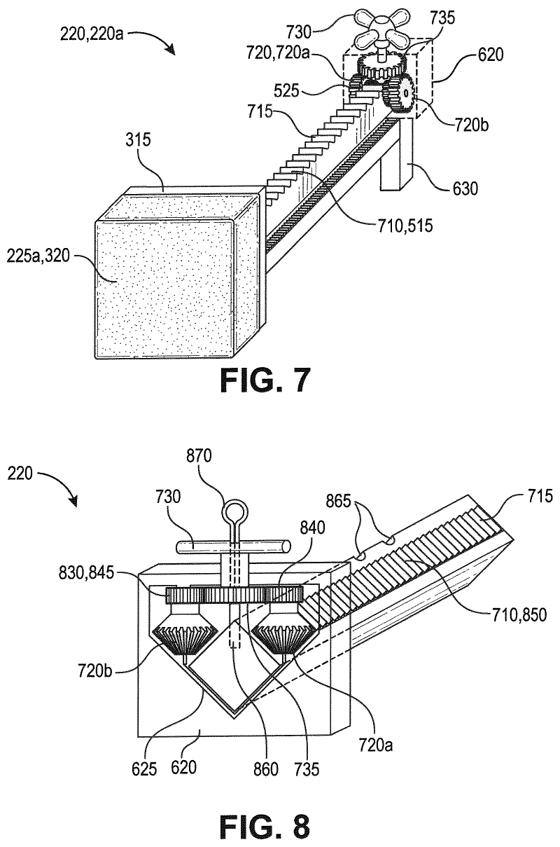

FIG. 5 shows a side view of the positioner arm 410. The positioner arm 410 of the present aspect can be a passive positioner arm 510 used in each of the passive positioner assemblies 230. The active positioner arm 710 (shown in FIG. 7) of the active positioner assembly 220 (shown in FIG. 2) can be substantially the same as the passive positioner arm 510 or can be different, as described in further detail below. In the present aspect, the passive positioner arm 510 can comprise a substantially elongated arm body 515 and the ball end 415 positioned at a first arm end 520, opposite a second arm end 525, of the arm body 515. The arm body 515 can comprise a plurality of ratchet teeth 530 arranged in series at least partially along the length of the arm body 515. The ratchet teeth 530 can be engaged by a pawl 610 (shown in FIG. 6) to selectively secure the passive positioner arm 510 in a desired orientation, as described in further detail below.

In example aspects, the passive positioner arm 510 can be made of a suitably rigid and/or sturdy material such as, for example and without limitation, plastic. In some aspects, the passive positioner arm 510 can comprise a radiolucent plastic material. Other plastic components of the patient positioning system such as, for example and without limitation, the base 310 (shown in FIG. 3) can comprise the radiolucent plastic material. In some aspects, the passive positioner arm 510 can comprise any other suitable material.

FIG. 6 illustrates an example aspect of one of the passive positioner assemblies 230. For example, the sternal passive positioner assembly 230a is shown, which can be similar to the thigh passive positioner assembly 230b (shown in FIG. 2). The sternal passive positioner assembly 230a can comprise the back pad 235a, which can comprise the base 310 and the cushioned pad portion 320. The back pad 235a can be connected to the ball end 415 of the passive positioner arm 510. The joint therebetween can allow rotation of at least 15 degrees in either direction. The passive positioner arm 510 can further be slidably mounted to an adjustment hub 620 of the passive positioner assembly 230. According to example aspects, the second arm end 525 of the passive positioner arm 510 can extend laterally into and/or through and can slide within a hub opening 625 of the adjustment hub 620. The pawl 610 can be mounted to the adjustment hub 620 and can engage a desired one (or more) of the ratchet teeth 530 of the passive positioner arm 510 to selectively lock the passive positioner arm 510 in place relative to the adjustment hub 620.

Additionally, in example aspects, the adjustment hub 620 can be coupled to the corresponding cleat or clamp 240 or other table attachment. In the present aspect, an upright or upright tube 630 can extend between the clamp 240 and the adjustment hub 620 to mount the adjustment hub 620 over the clamp 240. The clamp 240 can comprise a clamp body 640 defining a clamp slot 645 for receiving a rail 605 of the table 110. More specifically, each of the rail 605 and the clamp slot 645 can be substantially T-shaped. In some aspects, the rail 605 of the table 110 can be configured to slide within the clamp slot 645 to allow the passive positioner assembly 230 to be repositioned along a length of the table 110 as needed by only loosening a portion of the passive positioner assembly 230 and without disassembling any of the parts of the system 200. More specifically, each of the rail 605 and the clamp slot 645 can be oriented in a vertical direction. The clamp 240 can further comprise a screw lock 650, which can extend through the clamp body 640 to engage the rail 605. A pair of opposing clamp shoulders 655 can be defined by clamp slot 645, as shown. The screw lock 650 can be rotated and advanced towards the rail 605 to bias the rail 605 against the clamp shoulders 655 when tightened to securely affix the passive positioner assembly 230 in place along the rail 605.

As shown, the clamp 240 and the adjustment hub 620 or at least a portion thereof can be offset in a horizontal direction from the table 110; and the adjustment hub 620 and the positioner arm 510 can be offset in a vertical direction from the clamp 240 and the table 110. As also shown, the clamp 240 and the adjustment hub 620 or at least a portion thereof can be positioned outside an outer edge of the table 110 with respect to an outermost edge or surface of the table 110 defined on a corresponding side of the table 110; and the adjustment hub 620 and the positioner arm 510 can be positioned above the clamp 240 and the table 110 with respect to an outermost surface or edge of the table 110 defined on a corresponding side of the table 110. As shown, the upright 630 can extend in a vertical direction; and the positioner arm 510 can extend in a horizontal direction. As also shown, the positioner arm 510 can extend from a top end of the upright 630, and the upright 630 can be received within and terminate in the adjustment hub 620.

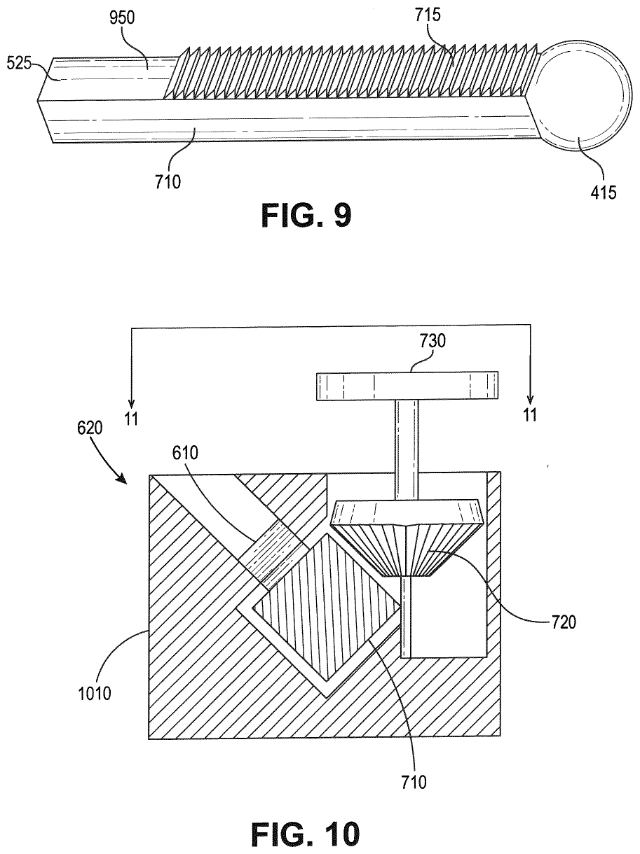

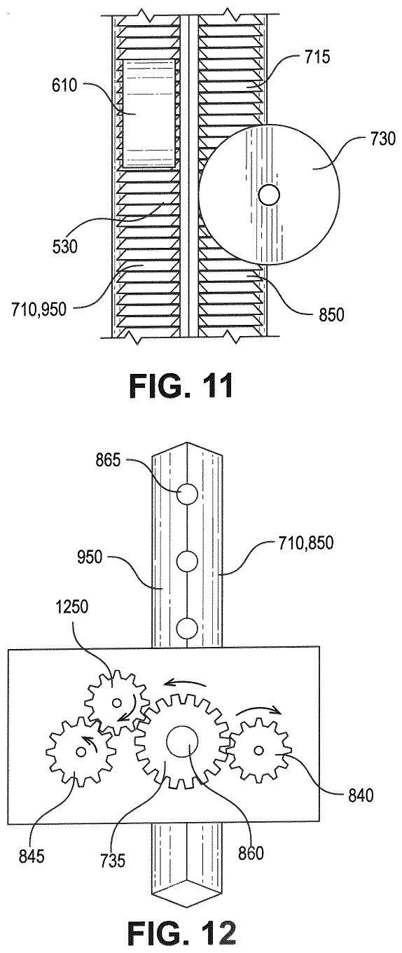

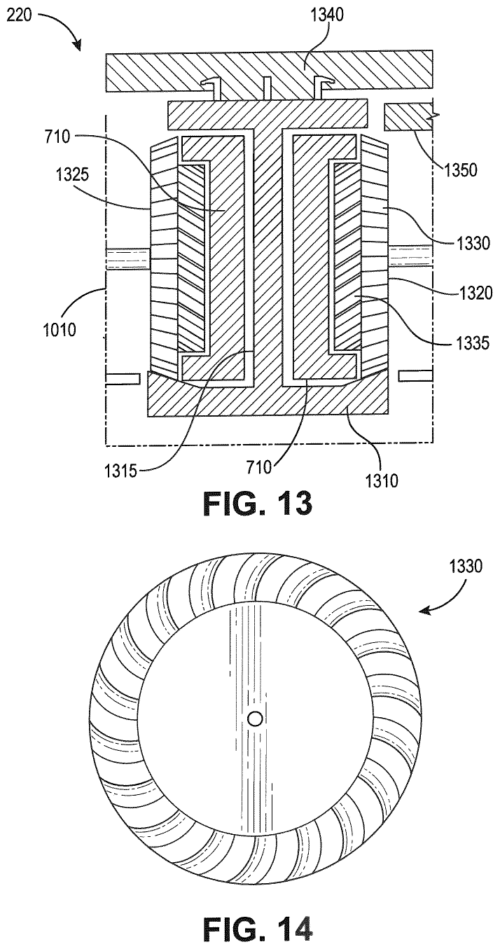

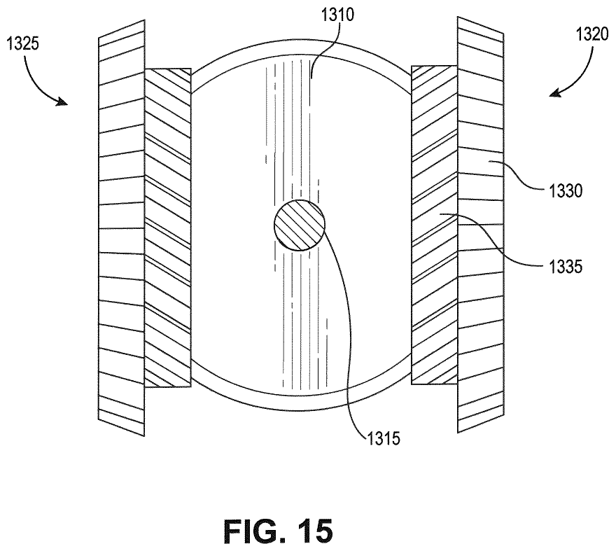

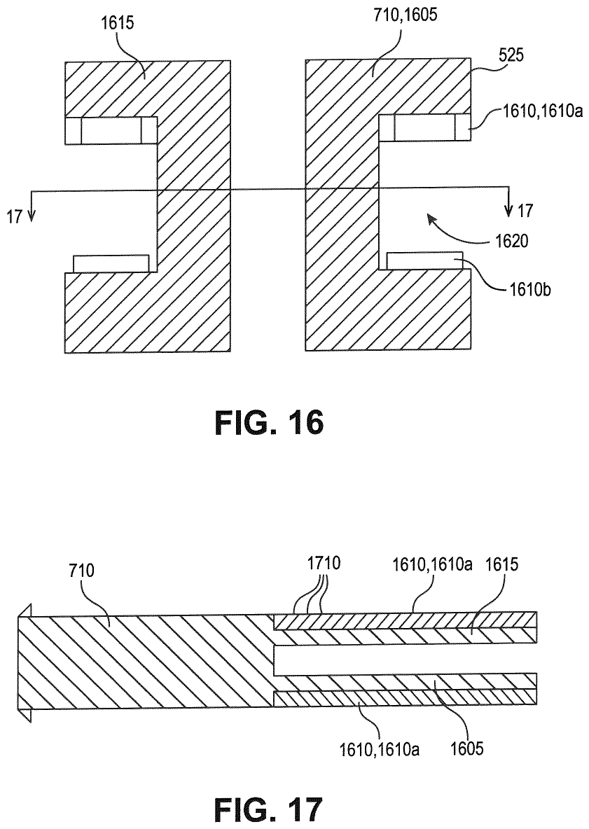

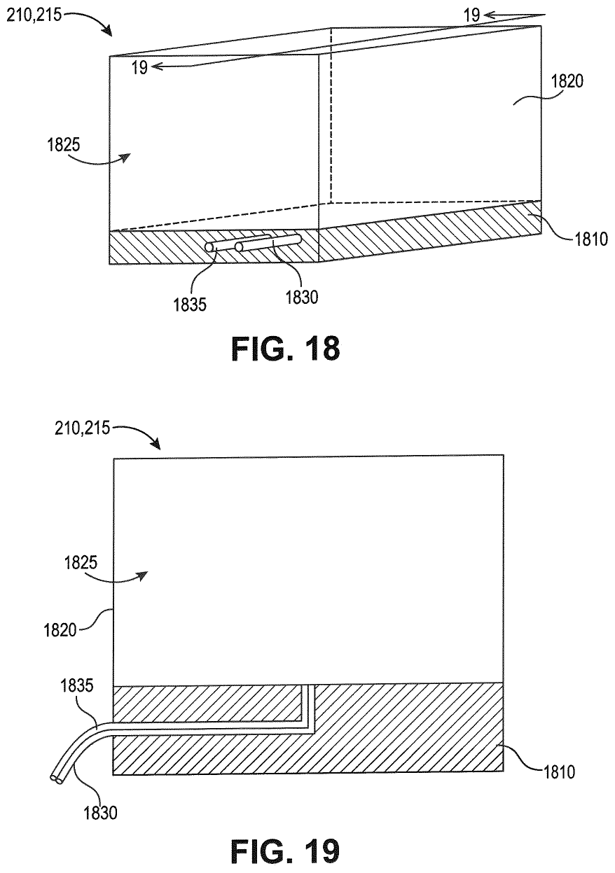

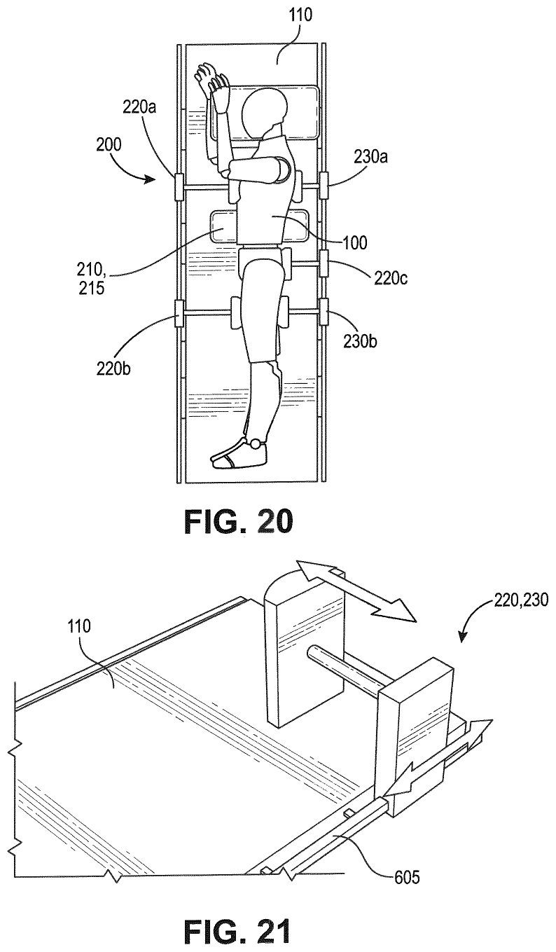

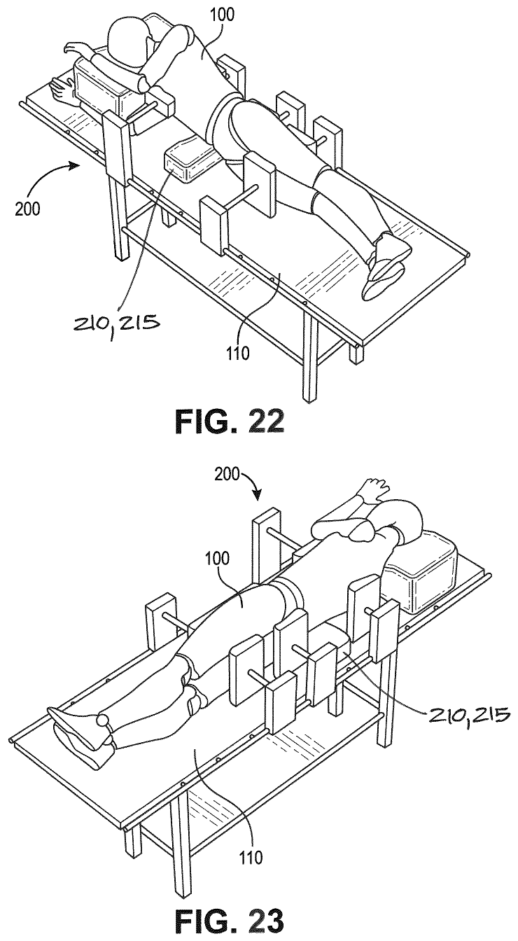

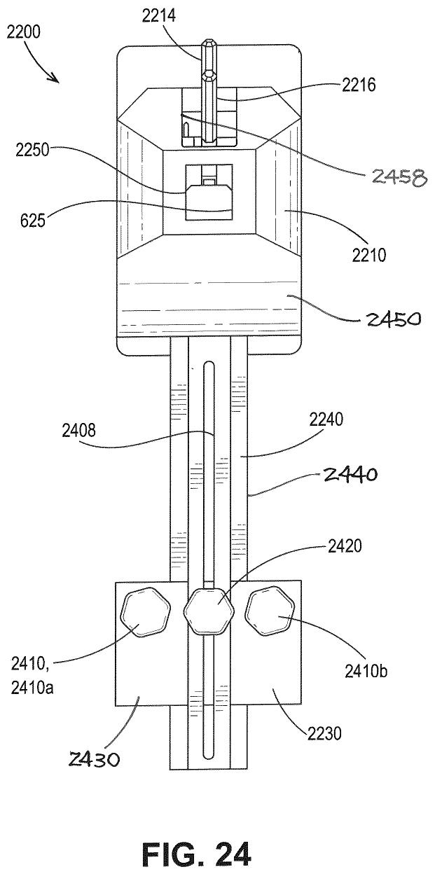

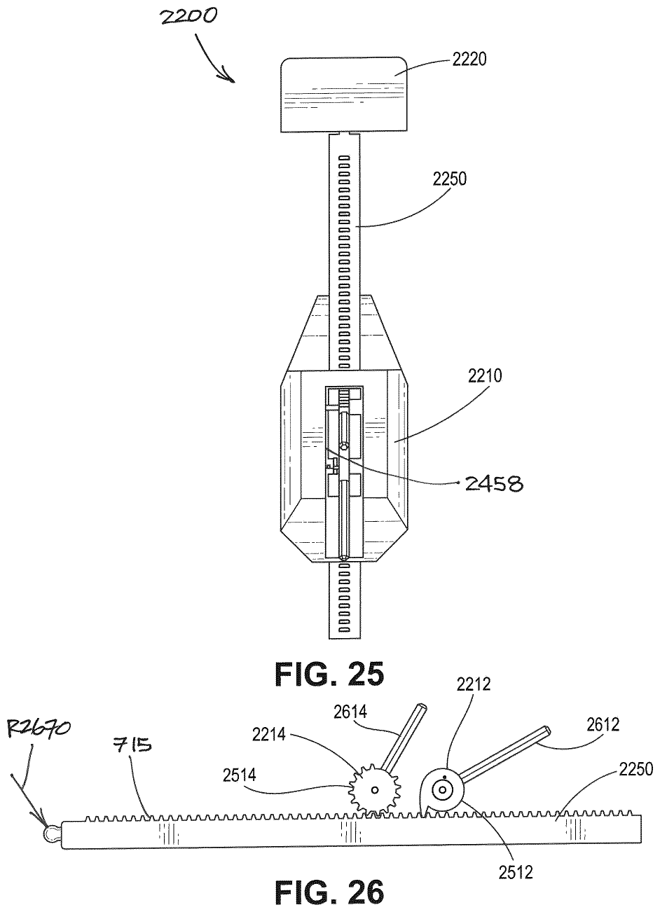

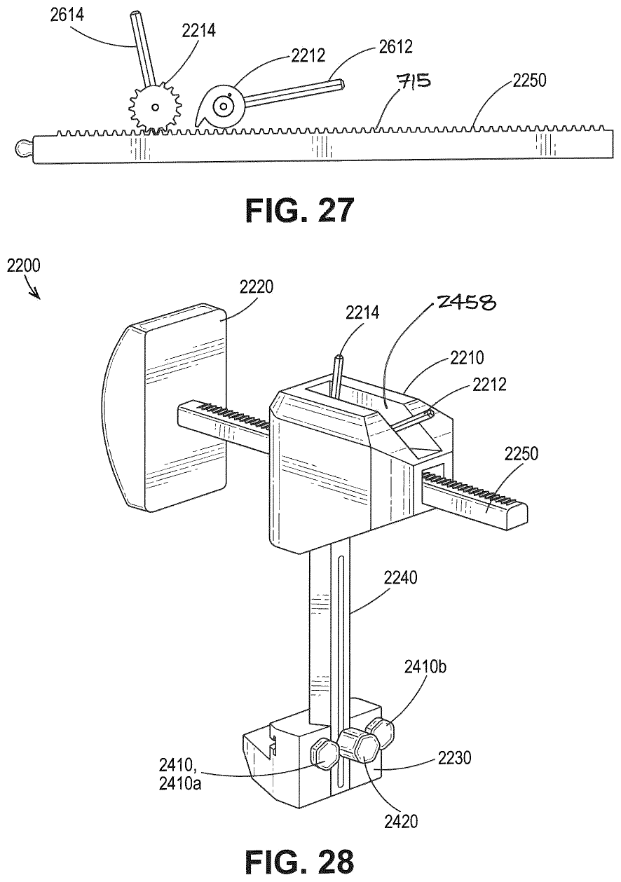

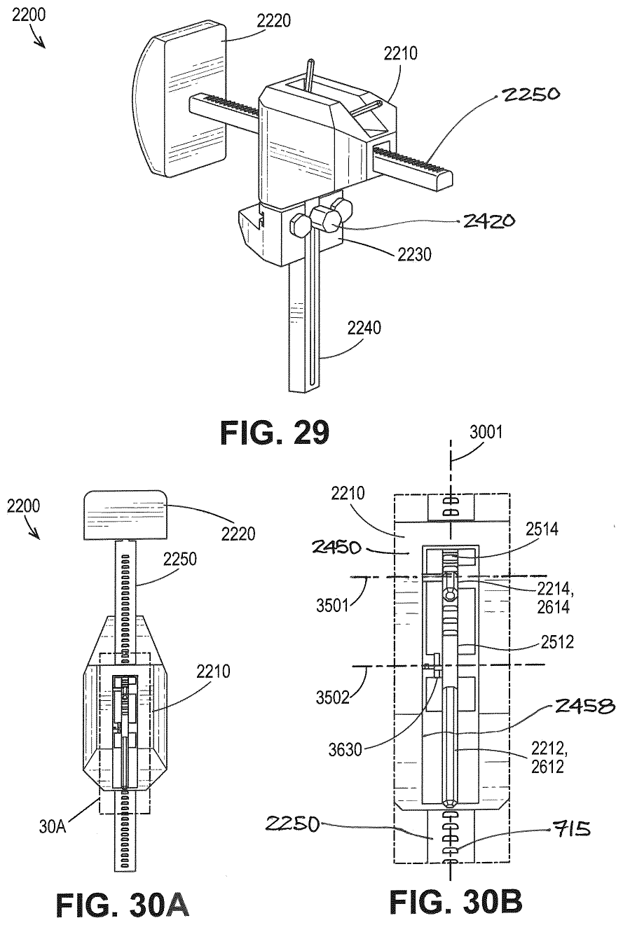

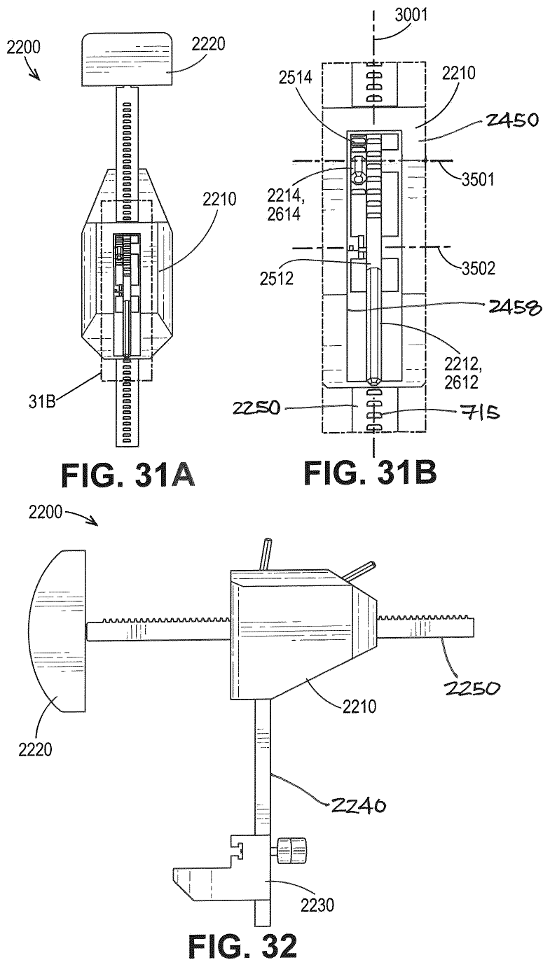

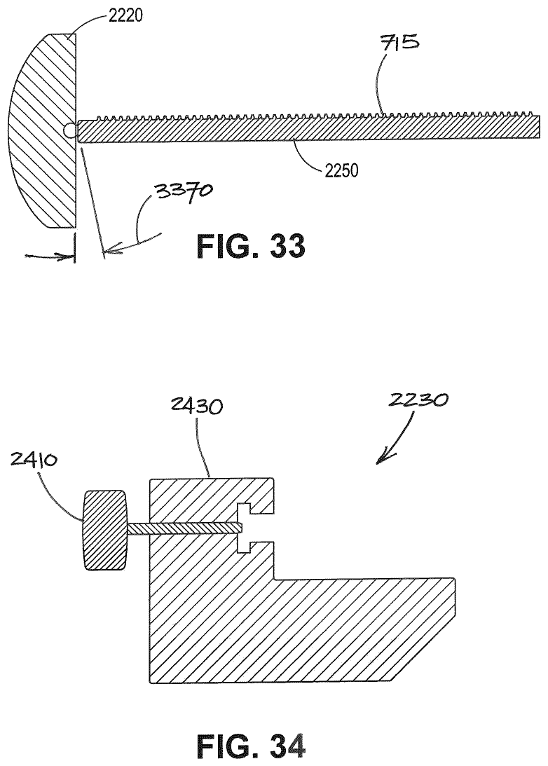

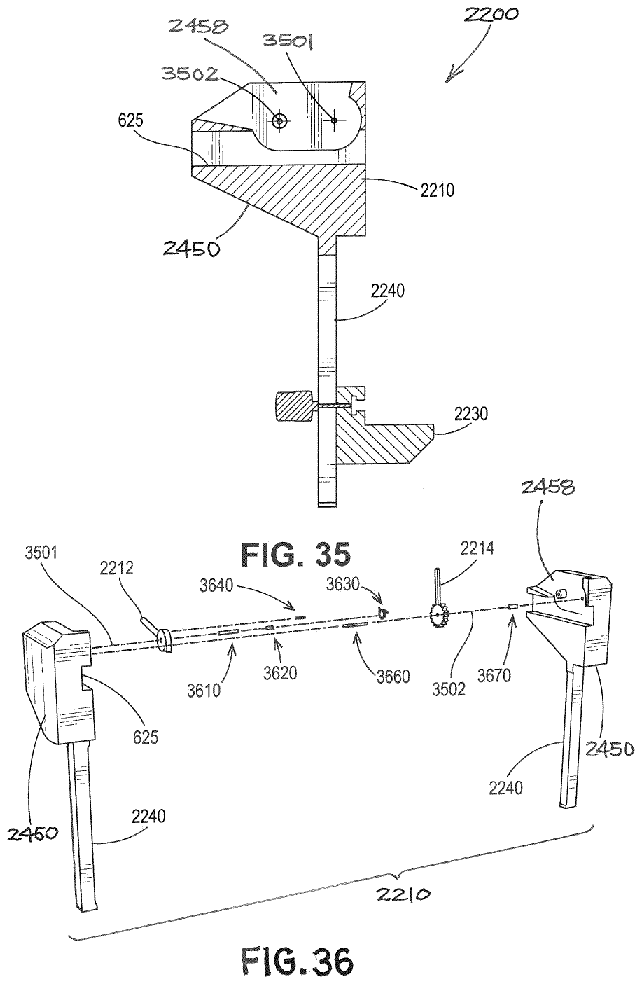

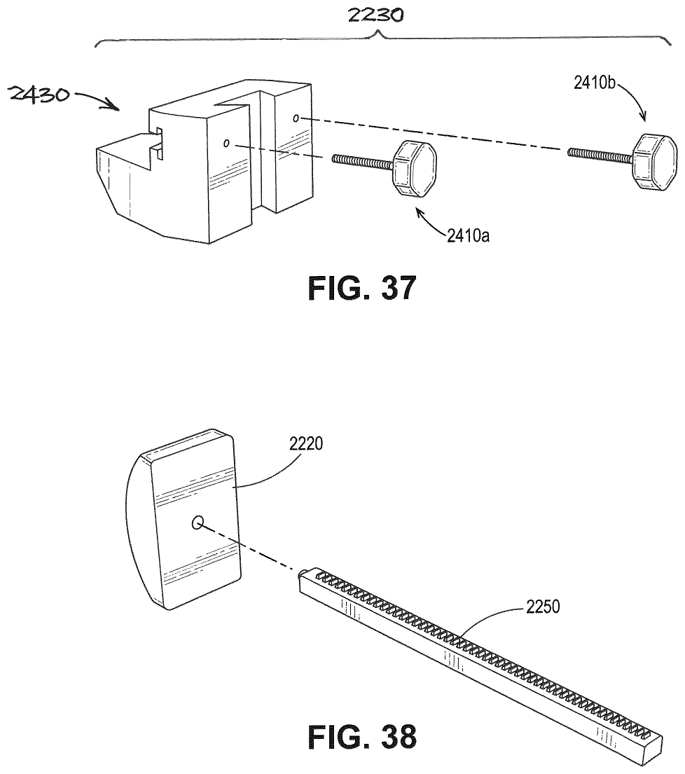

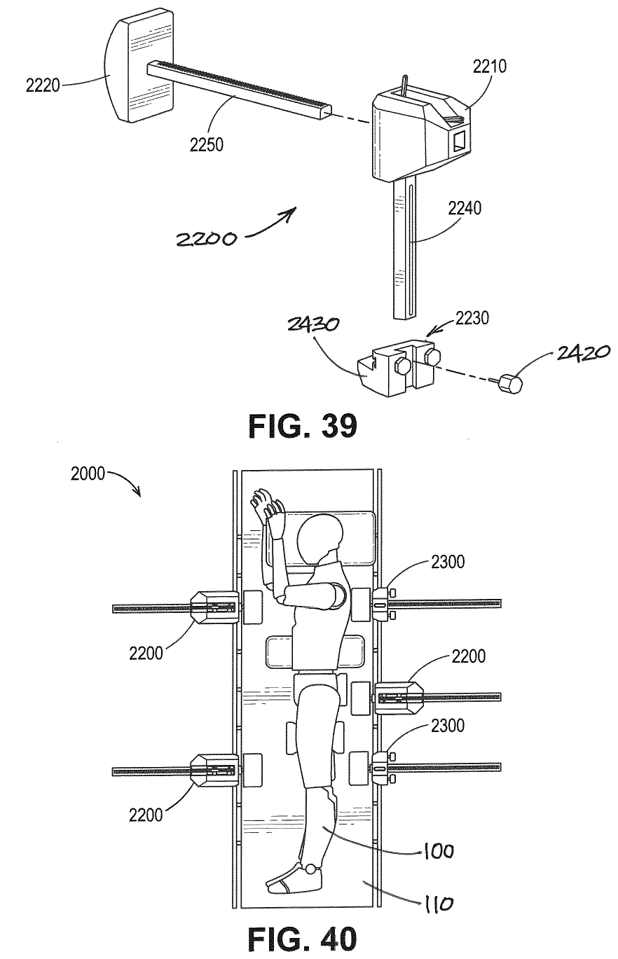

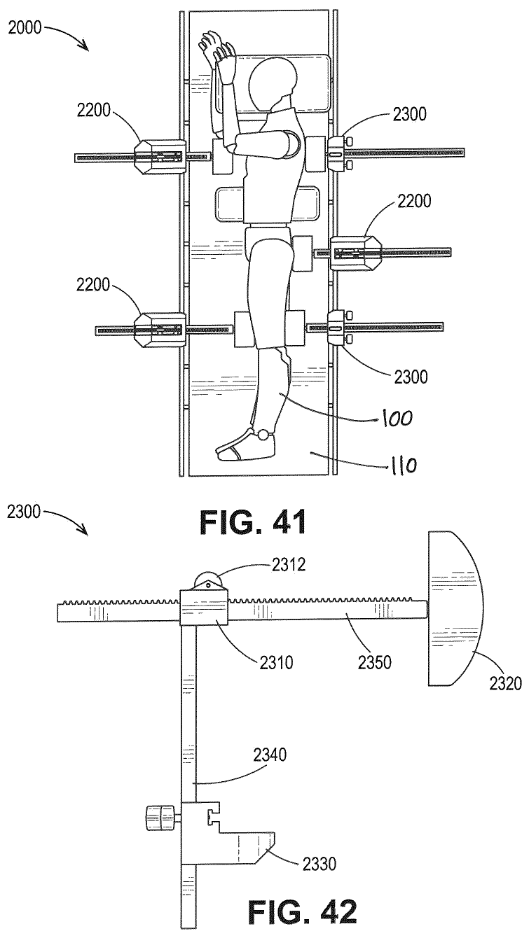

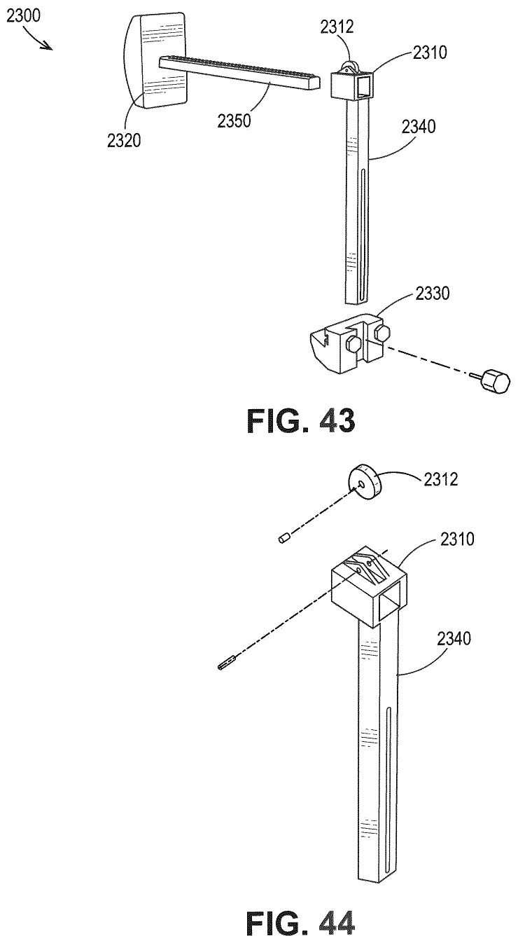

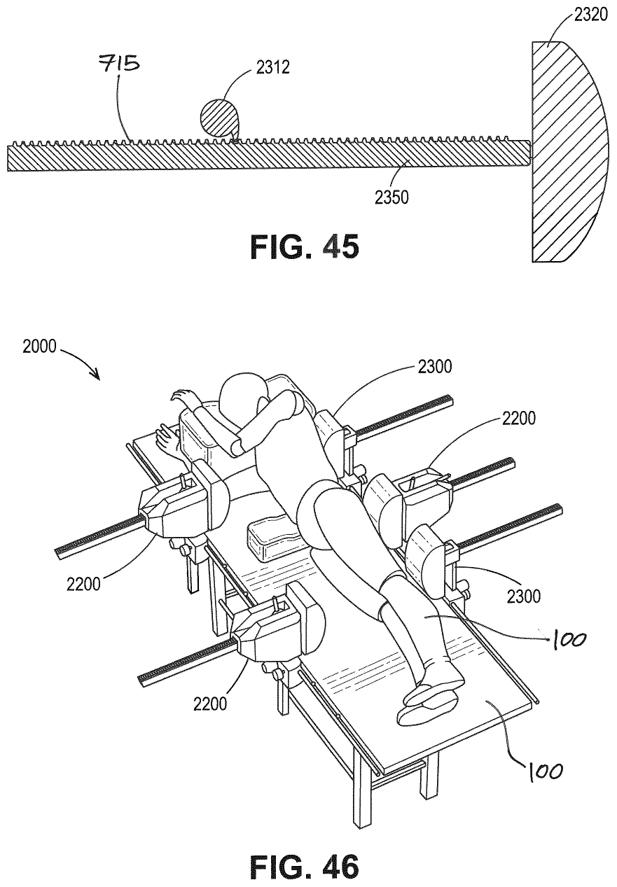

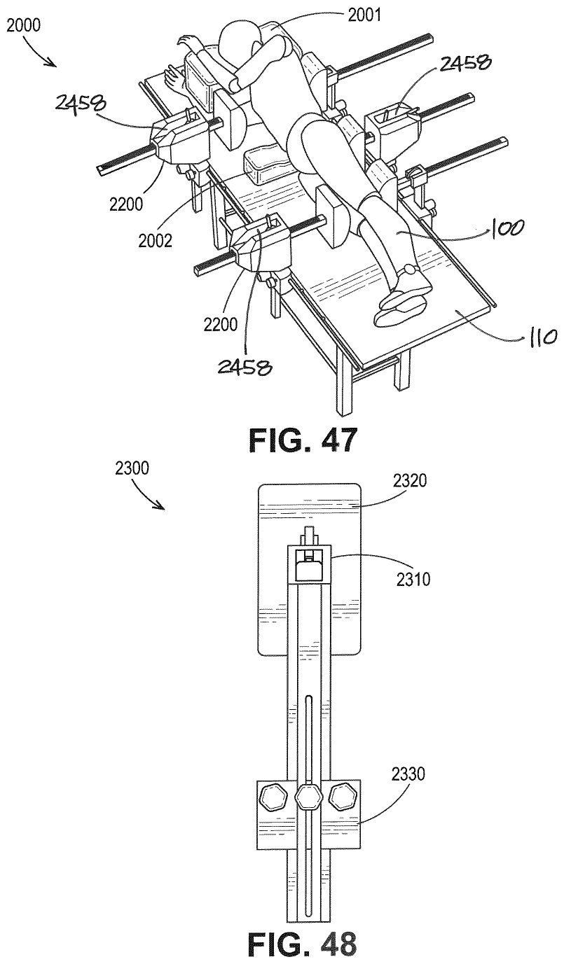

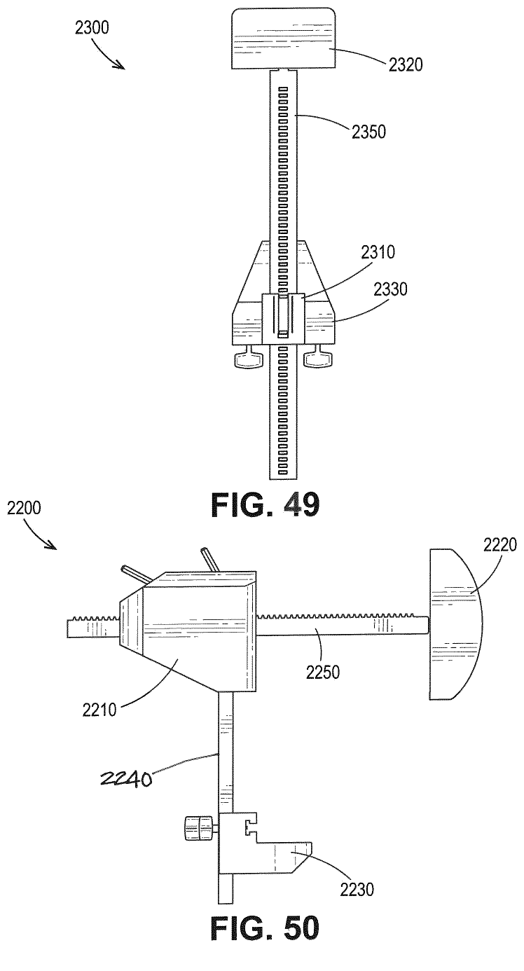

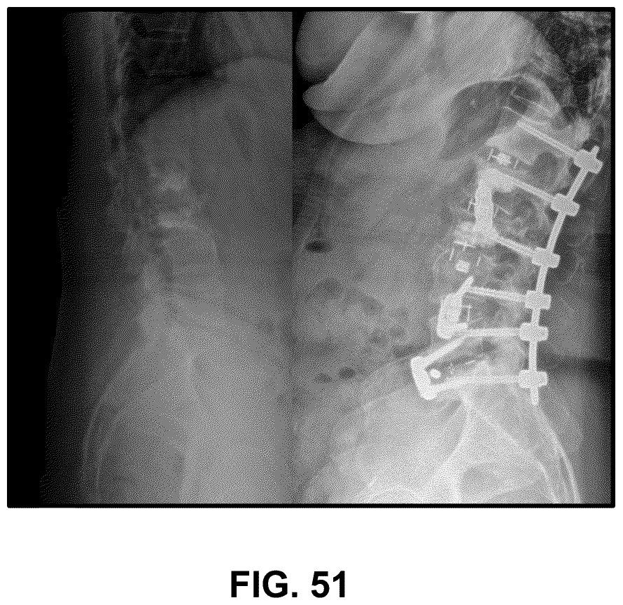

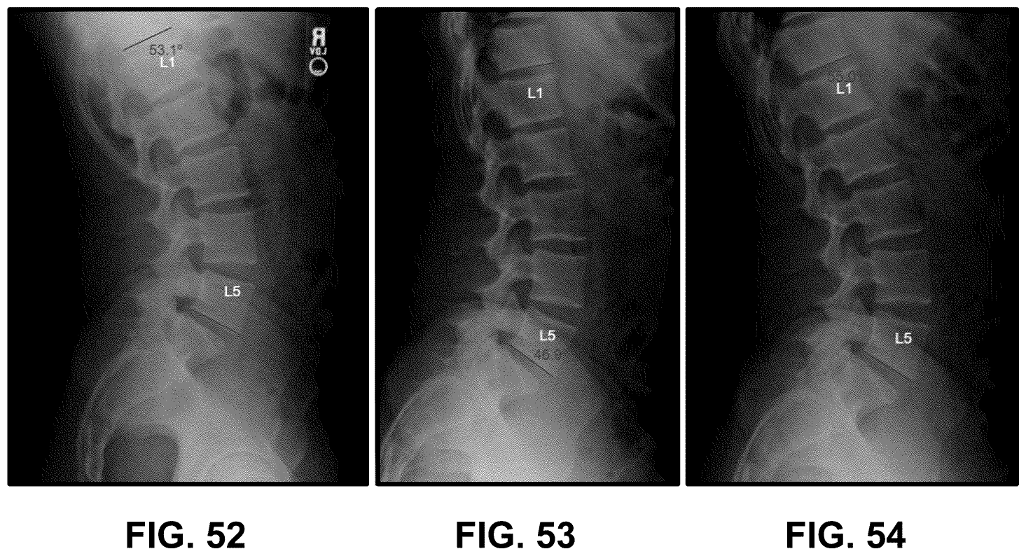

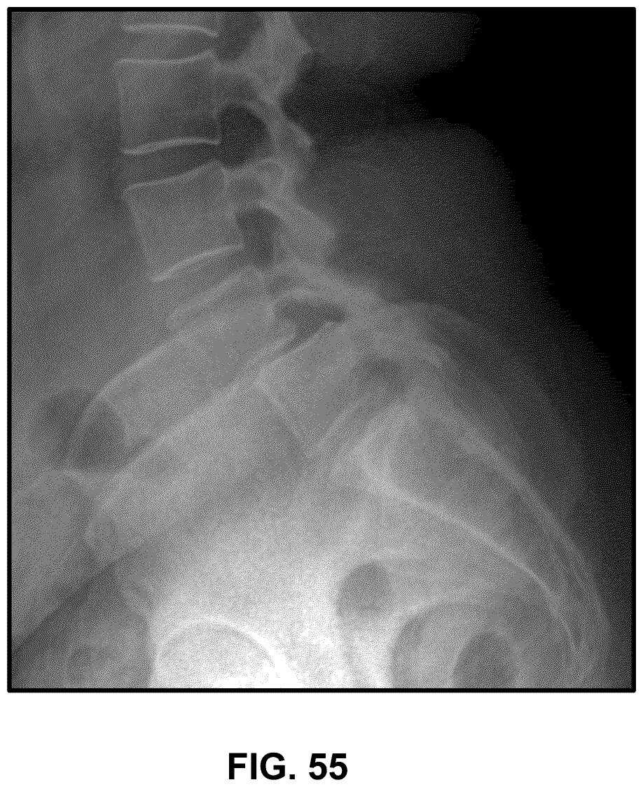

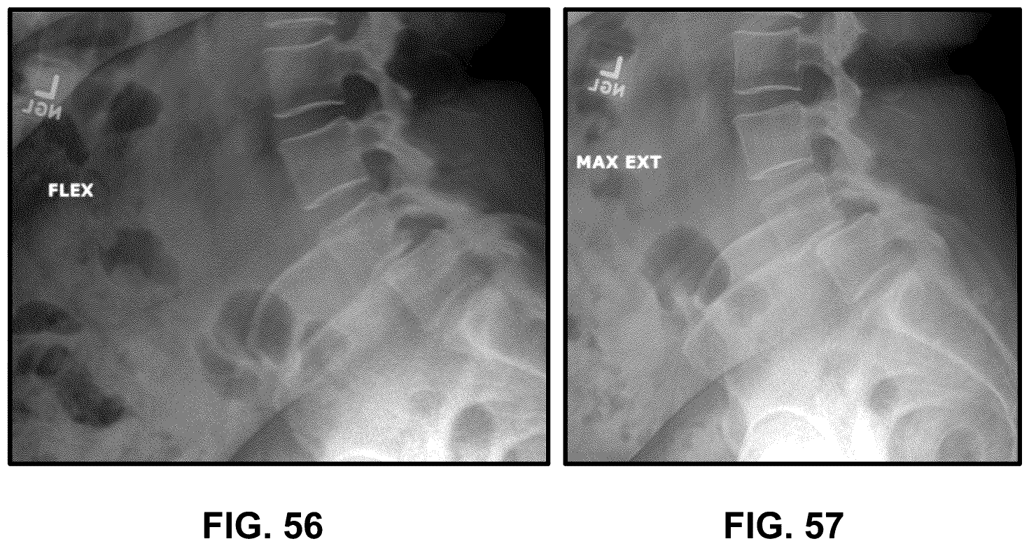

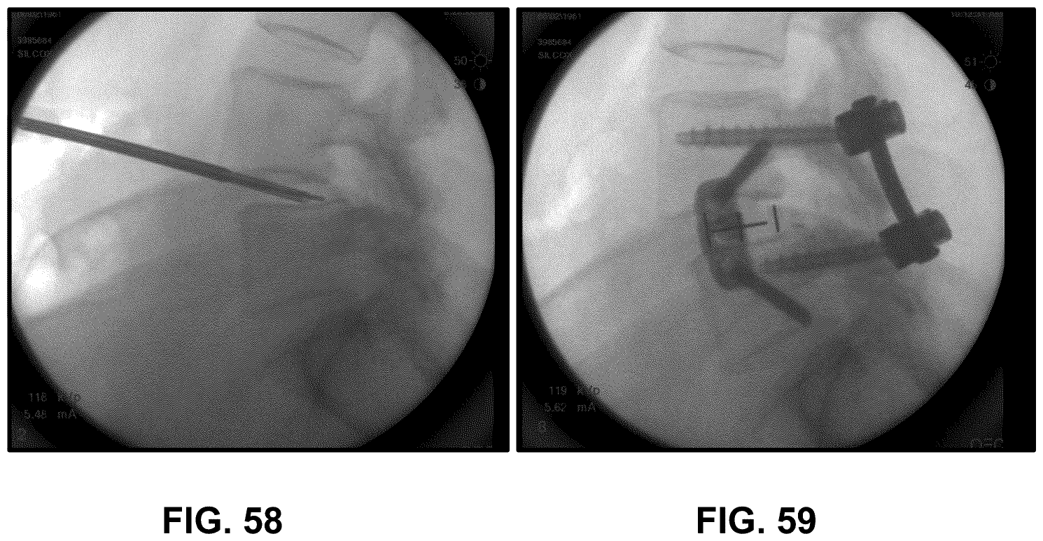

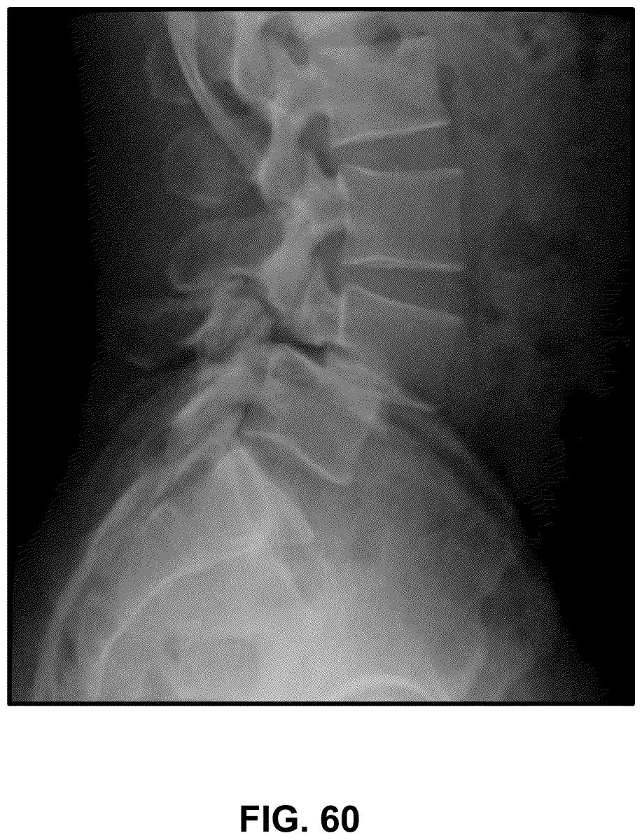

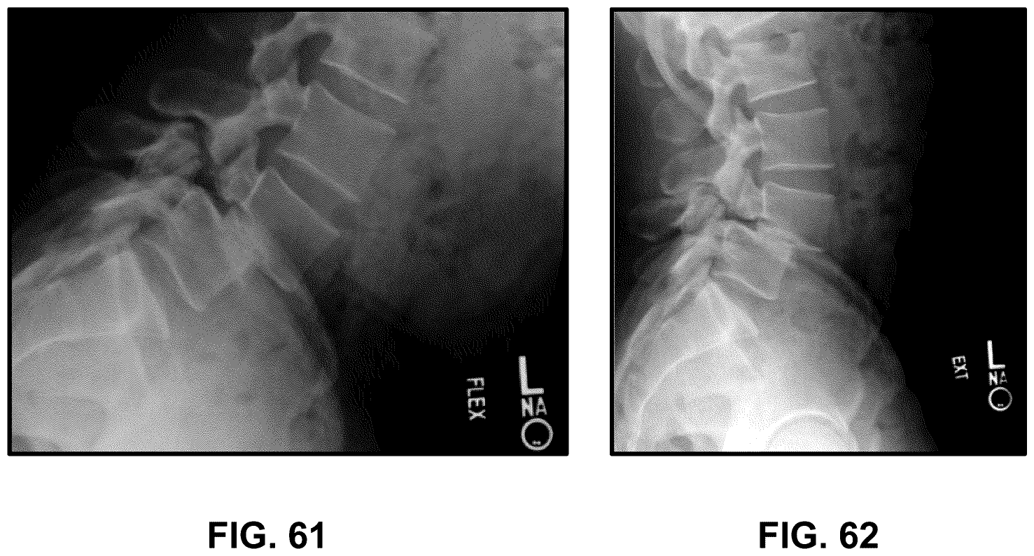

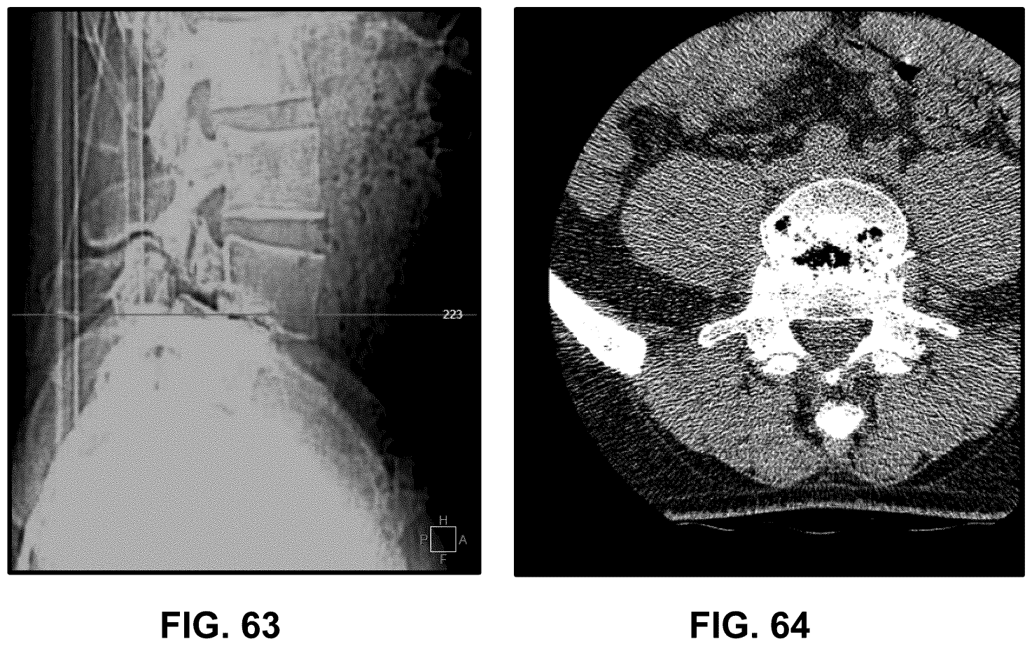

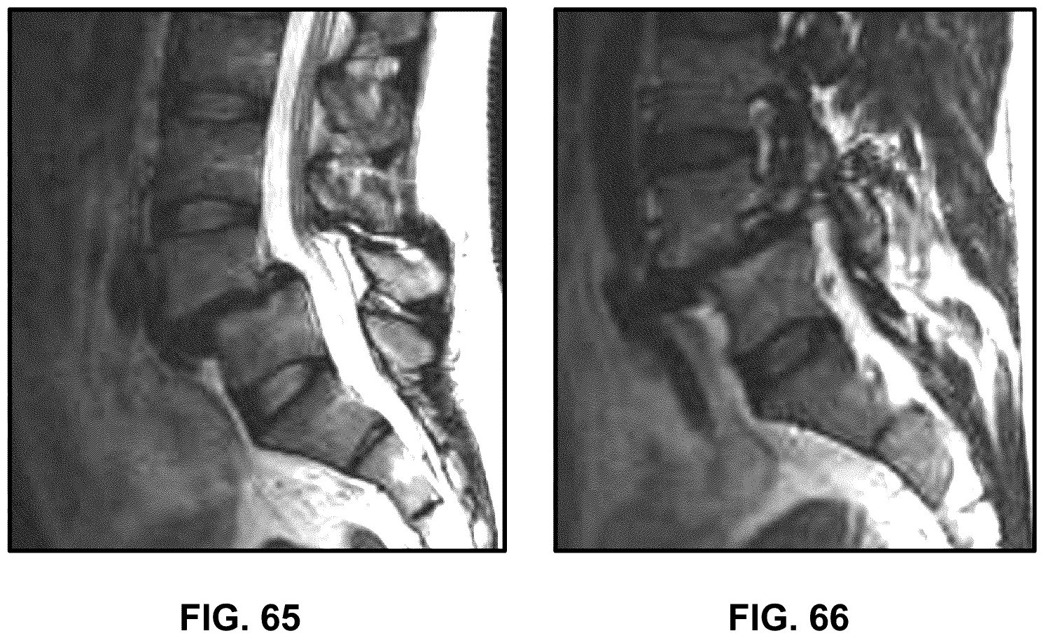

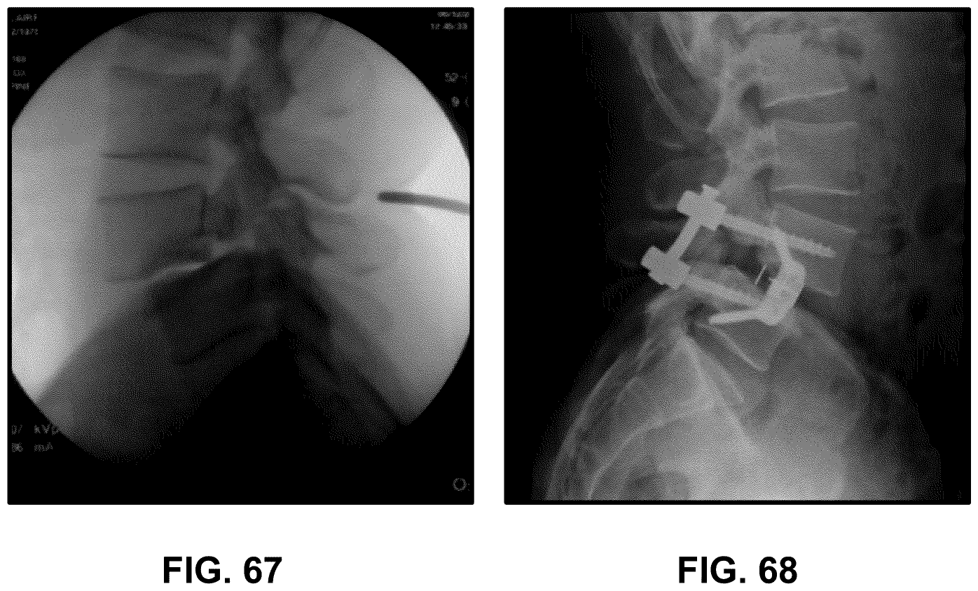

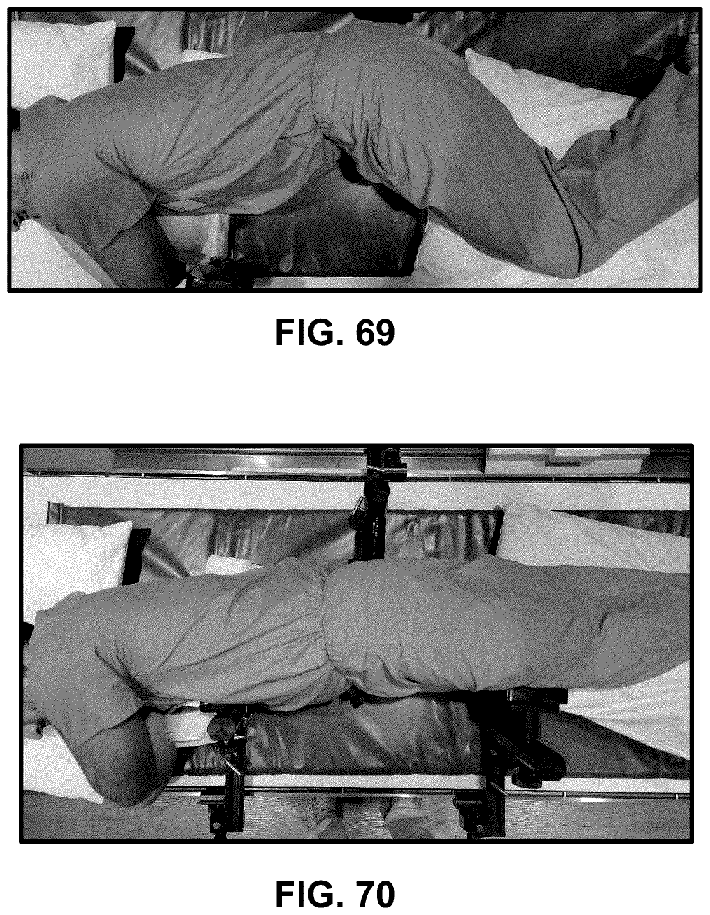

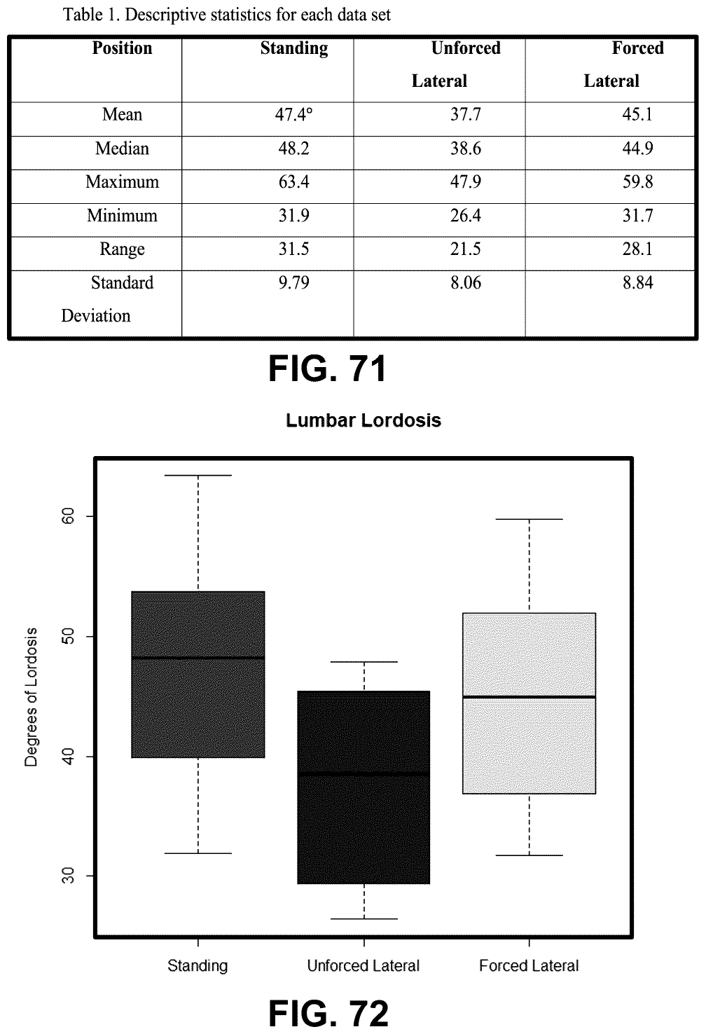

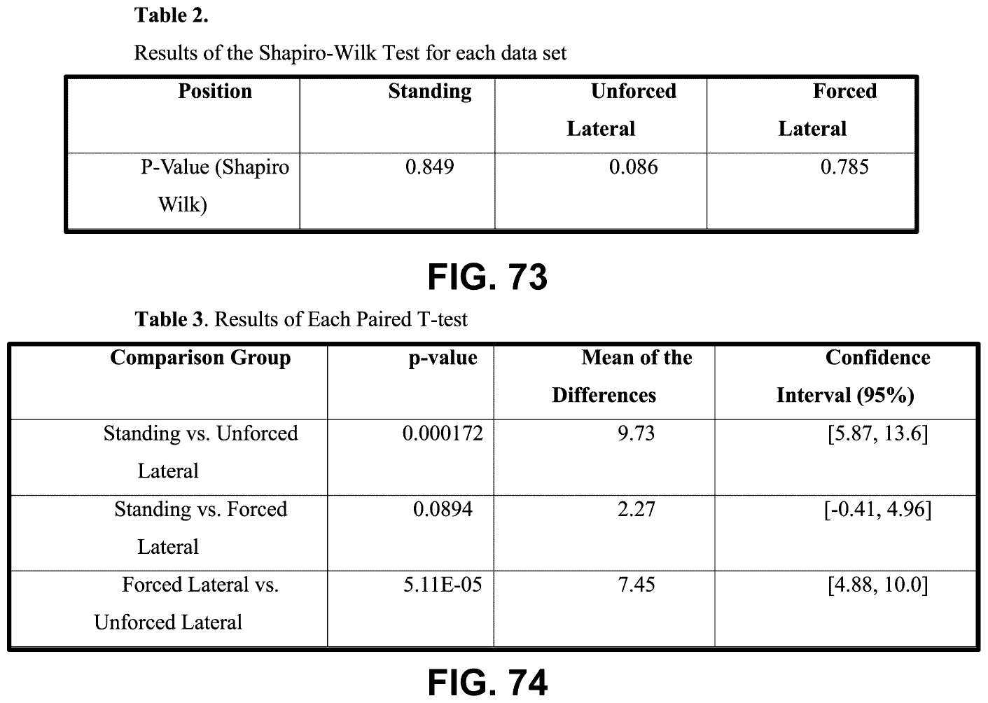

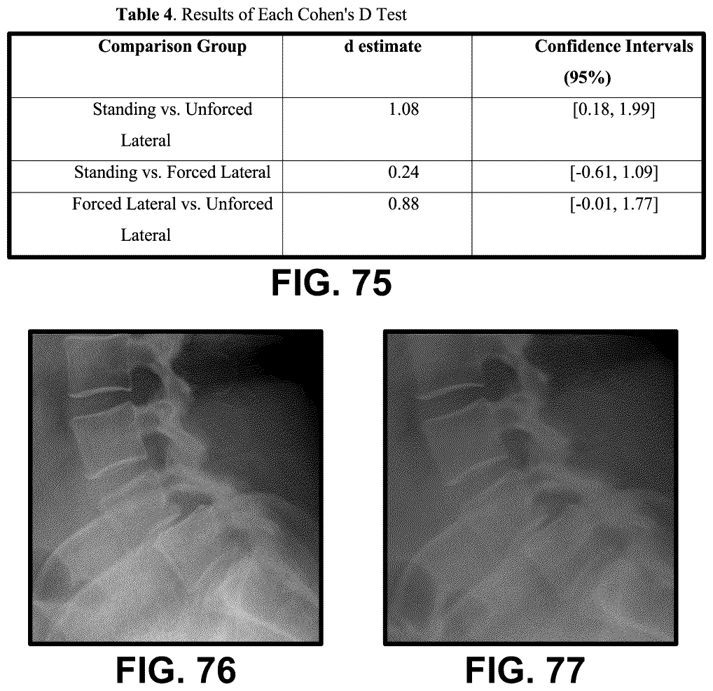

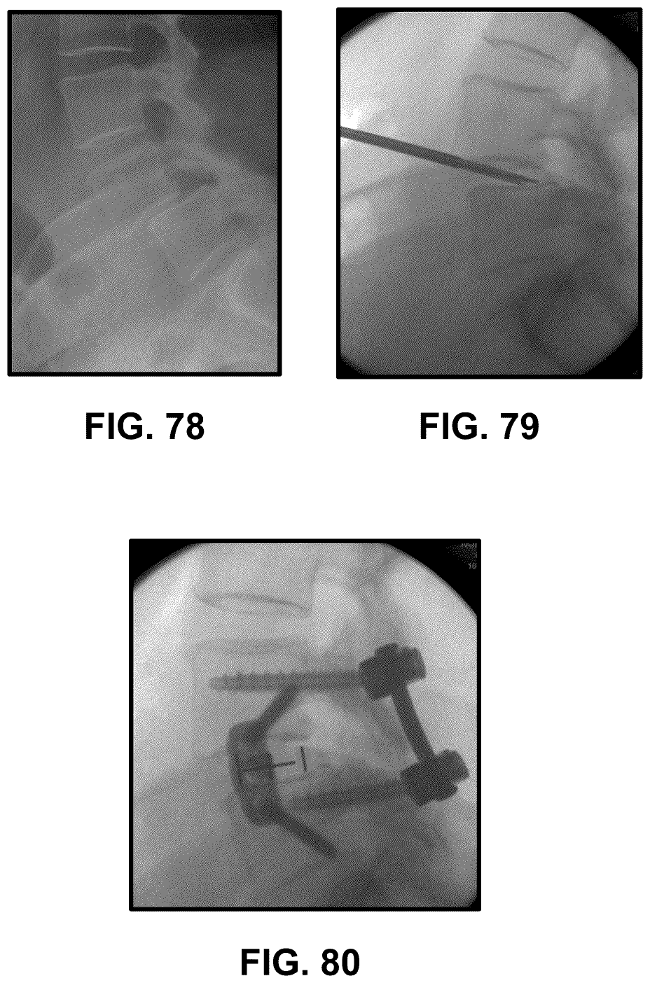

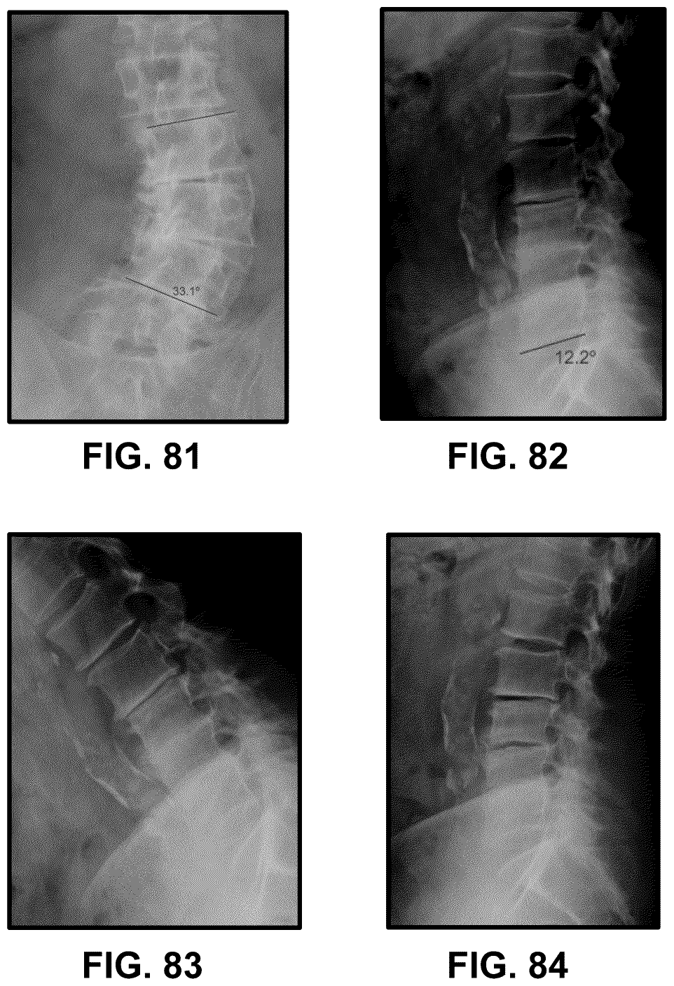

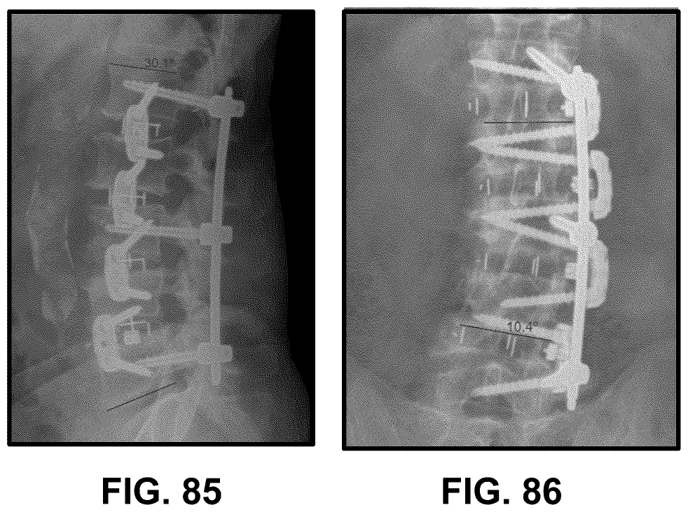

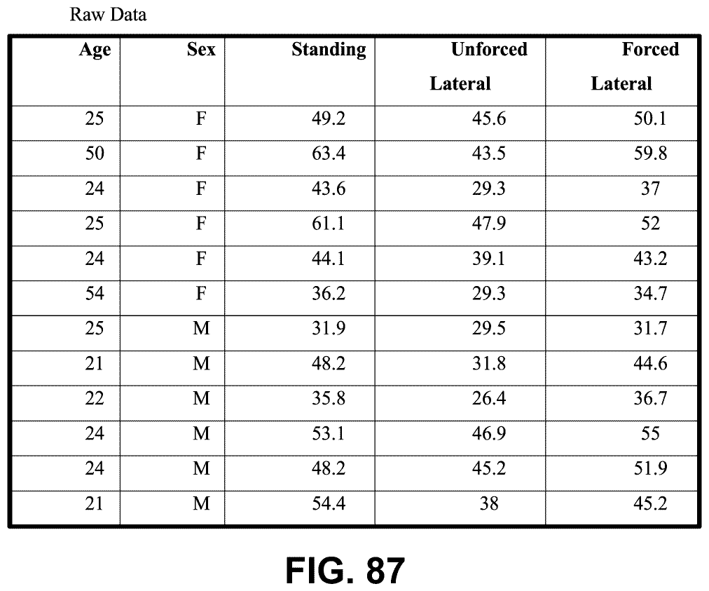

FIG. 7 illustrates an example aspect of one of the active positioner assemblies 220. For example, the sternal active positioner assembly 220a is shown, which can be similar to both the thigh active positioner assembly 220b and the sacral active positioner assembly 220c (both shown in FIG. 2). Various features of the active positioner assemblies 220 can be somewhat similar to those of the passive positioner assemblies 230 (shown in FIG. 2). The sternal active positioner assembly 220a can comprise the sternal pad 225a, which can comprise the base 310 and the cushioned pad portion 320. The sternal pad 225a can be connected to the ball end 415 (shown in FIG. 9) of the active positioner arm 710. The active positioner arm 710 can further be slidably mounted to the adjustment hub 620 of the active positioner assembly 220. According to example aspects, the second arm end 525 of the active positioner arm 710 can extend laterally into and/or through and can slide within the hub opening 625 (shown in FIG. 8) of the adjustment hub 620. Some aspects of the active positioner assembly 220 can further comprise the pawl 610 (shown in FIGS. 6 and 10). The pawl 610 can be mounted to the adjustment hub 620. The pawl 610 can be configured to engage a desired one (or more) of the ratchet teeth 530 (shown in FIG. 11) of the active positioner arm 710 to selectively lock the active positioner arm 710 in place relative to the adjustment hub 620. As previously described, example aspects of the active positioner assembly 220 can further comprise the upright 630 and the clamp 240 (shown in FIG. 6).

The sternal pad 225a of the sternal active positioner assembly 220a can be selectively adjusted to apply the force in the posterior (i.e., rear) direction A (shown in FIG. 2). As mentioned, the second arm end 525 of the active positioner arm 710 can slidably engage the adjustment hub 620. According to example aspects, the active positioner arm 710 can define a plurality of teeth or notches 715, which can be arranged in series at least partially along the length of the arm body 515. The notches 715 can be formed along one side of the arm body 515 or can be formed along multiple sides of the arm body 515. For example and without limitation, a length of the set of the notches can measure at or at most eight inches. According to example aspects, one or more gears 720 can be rotationally mounted within the adjustment hub 620 and configured to engage the notches 715 in the arm body 515. In some aspects, as shown, the gears 720 can be spur gears or straight-cut gears. For example, in the present aspect, the active positioner assembly 220 can comprise a first gear 720a and a second gear 720b, each of which can be configured to engage a corresponding row of the notches 715. When the first and second gears 720a,b are rotated, their engagement with the notches 715 in the active positioner arm 710 can linearly drive the active positioner arm 710 in the posterior direction A. More specifically, a first set of the teeth or notches 715, which can be defined along a center of the positioner arm 710, can be configured to engage the pawl 610. Such engagement can maintain a position of the positioner arm 710 with respect to the adjustment hub 620. Second and/or third sets of the notches 715 can be positioned on either lateral side of the first set of the notches 715 and can be configured to engage the respective gears 720a,b.

In some aspects, similarly as shown in FIG. 10, the gears 720a,b need not be used together, but rather a single gear 720 can be used. More specifically, the configuration shown can simply reflect, in a single assembly, the various configurations contemplated for use, even and including the various configurations contemplated for use independent of each other (e.g., the gear 720a on the one side, the gear 720b on the other side, and the teeth or notches 715). As implemented, certain configurations can be more beneficial (e.g., a single instance of the gear 720a or the gear 720b, or the gear arrangement shown in FIG. 12). In some aspects, more specifically, a third side gear 1250 (shown in FIG. 12) can be arranged between and rotationally engaged with each of the handle gear 735 and the second side gear 845 to create synchronized vectors of force, as shown and described with respect to FIG. 12 below. Specifically, such rotation of the second side gear 845 can result in synchronized or cooperative rotation of the first gear 720a and the second gear 720b resulting in translation of the positioner arm 710 with respect to the adjustment hub 620. More specifically, rotation of the handle 730 in the clockwise direction can cause rotation of the first gear 720a in counter-clockwise direction, viewing an outer face of the first gear 720a along an axis of the first gear 720a; and rotation of the handle 730 in the same clockwise direction can cause—through the third side gear 1250—rotation of the second gear 720b in clockwise direction, viewing an outer face of the second gear 720b along an axis of the second gear 720b. A connection between the handle gear 735 and the second gear 720b through both the second side gear 845 and the third side gear 1250 can cause rotation of the second gear 720b to become synchronized with rotation of the first gear 720a. Specifically, viewing the gears 720a,b along the same axis of rotation and from the same direction, the spur gears 720a,b can be made to rotate in the same direction and thereby facilitate or drive movement of the positioner arm 710 with respect to the adjustment hub 620.

A handle 730 or knob can extend from the adjustment hub 620, and the handle 730 can be rotated to drive the rotation of the gears 720 (and thereby to drive the movement of the sternal pad 225a and the active positioner arm 710 in the posterior direction A). More specifically, the handle 730 can be operatively connected to a handle gear 735, which can engage each of the gears 720 to rotate the gears 720 as the handle 730 is rotated. The handle 730 can be rotated manually or using any suitable tool, as needed.

FIG. 8 illustrates one of the active positioner assemblies 220 according to another example aspects. In some aspects, as shown, the gears 720 can be miter gears. The active positioner assembly 220 of FIG. 8 can be similar to the active positioner assembly 220 of FIG. 7. As shown, the handle 730 can be connected to a gear train 830 comprising the handle gear 735, a first side gear 840 rotationally engaged with the handle gear 735, and a second side gear 845. The first side gear 840 can rotationally engage the first miter gear 720a, and the second side gear 845 can rotationally engage the second miter gear 720b. Rotation of the handle 730 can thereby impart rotation to each of the first miter gear 720a and the second miter gear 720b. The first miter gear 720a can engage the notches or teeth 715 formed at a first arm side 850 of the active positioner arm 710, and the second miter gear 720b can engage the notches 715 formed at a second arm side 950 (shown in FIG. 9) of the active positioner arm 710.

In some aspects, again similarly as shown in FIG. 10, the miter gears 720a,b need not be used together, but rather a single miter gear 720 can be used. More specifically, the configuration shown can simply reflect, in a single assembly, the various configurations contemplated for use, even and including the various configurations contemplated for use independent of each other (e.g., the miter gear 720a on the one side, the miter gear 720b on the other side, and options for the teeth or options 715). As implemented, certain configurations can be more beneficial (e.g., a single instance of the miter gear 720a or the miter gear 720b, or the gear arrangement shown in FIG. 12). In some aspects, more specifically, the third side gear 1250 (shown in FIG. 12) can be arranged between and rotationally engaged with each of the handle gear 735 and the second side gear 845 to create synchronized vectors of force, as shown and described with respect to FIG. 12 below. Specifically, such rotation of the second side gear 845 can result in synchronized or cooperative rotation of the first miter gear 720a and the second miter gear 720b. More specifically, a rotation of the handle 730 in the clockwise direction can cause rotation of the first miter gear 720a in a counter-clockwise direction, viewing the first miter gear 720a through an outer or upper face of the first side gear 840 along an axis of the first side gear 840; and rotation of the handle 730 in the clockwise direction can cause—through the third side gear 1250—rotation of the second miter gear 720b in a clockwise direction, viewing the second miter gear 720b through an outer or upper face of the second side gear 845 along an axis of the second side gear 845. A connection between the handle gear 735 and the second gear 720b through both the second side gear 845 and the third side gear 1250 can cause rotation of the second gear 720b to become synchronized with rotation of the first gear 720a. Specifically, viewing the miter gears 720a,b from above the adjustment hub as oriented in FIG. 8, the miter gears 720a,b can be made to rotate in opposite directions and thereby facilitate or drive movement of the positioner arm 710 with respect to the adjustment hub 620.

In the present aspect, instead of the pawl 610 and ratchet teeth 530 (shown in FIGS. 6 and 5, respectively), the active positioner assembly 220 can comprise a spring-loaded positioner pin 860 configured to selectively engage and disengage a plurality of positioner holes 865 formed along the active positioner arm 710. As shown, the spring-loaded positioner pin 860 can be mounted to the adjustment hub 620, and can be naturally biased towards the active positioner arm 710 to engage one of the positioner holes 865. When the spring-loaded positioner pin 860 is engaged with one of the positioner holes 865, the active positioner arm 710 can be locked in position relative to the adjustment hub 620. To allow the active positioner arm 710 to slide relative to the adjustment hub 620, the positioner pin 860 can be disengaged from the positioner hole 865. For example, in the present aspect, a knob 870 can be mounted to the positioner pin 860 external to the adjustment hub 620, and the knob can be gripped and pulled upward to overcome the spring force and retract the positioner pin 860 from the positioner hole 865. FIG. 9 illustrates an example aspect of the active positioner arm 710.

FIGS. 10 and 11 illustrate a cross-sectional view and a top view, respectively. of the active positioner assembly 220 in accordance with another example aspect. Again, a single gear 720, which can be driven directly by the handle 730, can be configured to facilitate or drive movement of the positioner arm 710 with respect to the adjustment hub 620. The gear 720, the pawl 610, and at least a portion of the positioner arm 710 can be received within a housing 1010. As shown, the pawl 610 can engage one set of the teeth or notches 715, and the gear 720 can engage another set of the teeth or notches 715 (shown in FIG. 11).

FIG. 12 illustrates a top view of the active positioner assembly 220. The active positioner assembly 220 of FIG. 12 can be similar to or substantially the same as the active positioner assembly 220 of FIG. 8. As shown, the active positioner assembly 220 can comprise the third side gear 1250. In the present aspect, the third side gear 1250 can be arranged between and rotationally engaged with each of the handle gear 735 and the second side gear 845. This multi-gear movement can create synchronized vectors of force to move the positioner arm 710. Each of the handle gear 735, the first side gear 840, the second side gear 845, and the third side gear 1250 can rotate in the directions indicated by the directional arrows. In the interest of compact disclosure, not every possible gear train or gear combination is shown or disclosed. It is within the scope of the disclosure that a single gear or a plurality of gears working together can advance or retract the positioner arm 710 in a controlled manner.

FIGS. 13-17 illustrate various views of the active positioner assembly 220 in accordance with another example aspect. The active positioner assembly 220 can comprise one or more of the various components and configurations shown. Referring to the cross-sectional view of FIG. 13, in the present aspect, the active positioner assembly 220 can comprise a miter cog 1310 with a central post 1315. The miter cog 1310 can be configured to engage and rotate a first miter gear assembly 1320 and a second miter gear assembly 1325. Each of the first miter gear assembly 1320 and the second miter gear assembly 1325 can comprise an outer miter gear 1330 and an inner pinion 1335. As the miter cog 1310 is driven, such as by rotating a cap, knob, or handle 1340 attached thereto, the miter cog 1310 can engage and rotate each of the outer miter gears 1330, which in turn can rotate the corresponding inner pinions 1335. Each of the inner pinions 1335 can rotationally engage a corresponding linear rack 1610 (shown in FIG. 16) of the active positioner arm 710 to drive the linear movement of the active positioner arm 710. As shown, at least some of the components (e.g., the miter cog 1310 and the gear assemblies 1320,1325) can be positioned within the housing 1010. As shown, cap catch posts, shown with barbs, can be positioned at a top end of the structure comprising the miter cog 1310 and the miter post 1315 and can be received within and securably attach the handle 1340. FIG. 14 illustrates a side view of the outer miter gear 1330, and FIG. 15 illustrates a top view of the miter cog 1310 and the first and second miter gear assemblies 1320,1325. In some aspects, similarly as shown in FIG. 10, the gear assemblies 1320,1325 need not be used together. Rather, the configurations shown can simply reflect, in a single assembly, the various configurations contemplated for use, even and including the various configurations contemplated for use independent of each other (e.g., the gear assembly 1320 on the one side, the gear assembly 1325 on the other side, and various options for the linear rack 1610). As implemented, certain configurations can be more beneficial (e.g., a single instance of the gear assembly 1320 or the gear assembly 1325, or the gear combination shown in FIG. 12).

FIGS. 16 and 17 illustrate an end view and a cross-sectional view, respectively, of the active positioner arm 710. As shown, the active positioner arm 710 can define a first prong 1605 and a second prong 1615 at the second arm end 525 thereof. Each of the first prong 1605 and the second prong 1615 can define a substantially C-shaped profile, which can define a recess 1620 configured to receive the corresponding inner pinion 1335 (shown in FIG. 13). Each of the first prong 1605 and the second prong 1615 can further define the corresponding linear rack 1610, which can define a plurality of rack teeth 1710 (shown in FIG. 17). In some aspects, the rack 1610 can comprise both an upper rack 1610a and a lower rack 1610b, either of which can engage the corresponding inner pinion 1335. More specifically, among the upper rack 1610 and the lower rack 1610b of each of the first prong 1605 and the second prong 1615, i.e., a set of four racks 1610a,b, a single gear assembly 1320,1325 can engage a single instance of the rack 1610a,b to drive or facilitate movement of the positioner arm 710. In some aspects, a cap cog 1350, shown only in part, can selectively engage and disengage, in a radial direction in some aspects, a portion of the active positioner assembly 220 proximate to the handle 1340. The cap cog 1350 can thereby lock a rotational position of the miter cog 1310 with respect to the housing 1010.

FIGS. 18 and 19 illustrate a perspective view and a cross-sectional view, respectively, of the bladder 210 (e.g., the air bladder 215). According to example aspects, the air bladder 215 can comprise a padding portion 1810 and an inflatable bladder portion 1820. The inflatable bladder portion 1820 can define an air cavity 1825 into which air can be blown or from which air can be withdrawn to selectively adjust the volume of the inflatable bladder portion 1820. In some aspects, the air bladder 215 can comprise an air inlet tube 1830 and an air outlet tube 1835, each connected to the air cavity 1825 of the inflatable bladder portion 1820. Air can be blown into the air cavity 1825 through the inlet tube 1830 and can be withdrawn from the air cavity 1825 through the outlet tube 1835. In other aspect, the inlet tube 1830 and the outlet tube 1835 can be combined into a singular tube. In some aspects, each of the inlet tube 1830 and the outlet tube 1835 can be connected to an air compressor (not shown), which can control the flow of air into and out of the inlet and outlet tubes 1830,1835, respectively. The padding portion 1810 can be constructed of structural padding. More specifically, the padding portion 1810 can define a channel through which the air inlet tube 1830 and the air outlet tube 1835 run. In this way, the padding portion 1810 can be configured to prevent the creation of kinks in the inlet tube 1830 or the outlet tube 1835.

FIGS. 20-23 illustrate various views of the patient 100 positioned on the table 110 using an embodiment of the patient positioning system 200 in accordance with another example aspect. FIG. 20 illustrates a top view of the patient 100 positioned on the table 110 using the patient positioning system 200. More specifically, FIG. 20 shows, in position against the patient 100, three active positioner assemblies 220a,b,c and two passive positioner assemblies 230a,b. FIG. 20 also shows the bladder 210, which can be the air bladder 215, in a position between the table 110 and the patient 100. FIG. 21 illustrates one of the active positioner assemblies 220 slidably and/or adjustably mounted to the rail 605 of the table 110. The active positioner assembly 220 can be repositioned along a length of the table 110 as needed by only loosening a portion of the active positioner assembly 220 and without disassembling any of the parts of the system 200. Each of the passive positioner assemblies 230 (shown in FIG. 2) can similarly be slidably and/or adjustably mounted to the table 110. FIG. 22 illustrates a front perspective view of the patient 100 positioned on the table 110 using the patient positioning system 200. FIG. 23 illustrates a rear perspective view of the patient 100 positioned on the table 110 using the patient positioning system 200. As shown, the positioning pads 225/235 can extend downward to a surface of the table 110 and/or can extend upward past at least a central or sagittal plane of a body of the patient 100 in order to apply pressure against the patient 100. A full height of the positioning pads 225/235 can extend from or proximate to the table to a point vertically extending past the sagittal plane of the patient 100. The various features and configurations of the patient positioning system 200 described herein are merely examples and should not be considered limiting.

FIGS. 24-39 and 50 are various views of an active positioner assembly or active positioning apparatus or patient positioning apparatus 2200, in accordance with various aspects of the disclosure. FIGS. 24 and 25 are specifically rear and top views of the active positioning apparatus 2200. As shown in FIG. 24, the active patient positioning apparatus 2200 can comprise an adjustment hub 2210, which can comprise a body 2450 defining an access opening or access cavity or cavity 2458. The active patient positioning apparatus 2200 can further comprise a positioner arm 2250, which can define a proximal end and a distal end. More specifically, the proximal end can be insertably received by the adjustment hub 2210, and the distal end can be attached or coupled to the positioning pad 2220. The adjustment hub 620 can be coupled to a cleat or clamp 2230 or other table attachment. More specifically, the clamp 2230 and the adjustment hub 2210 or at least a portion thereof can be offset in a horizontal direction from the table 110; and the adjustment hub 2210 and the positioner arm 2250 can be offset in a vertical direction from the clamp 2230 and the table 110 (shown in FIG. 2). The positioner arm 2250 can be received within the hub opening 625.

In the present aspect, an upright or upright tube 2240 can extend between the clamp 2230 and the adjustment hub 2210 to mount the adjustment hub 2210 over the clamp 2230. As shown, the upright 2240 can extend in a vertical direction. The upright 2240 can comprise a body 2440, which can define a elongated opening or slot 2408. More specifically, the slot 2408 can facilitate vertical adjustment of the upright 2240 with respect to the claim 2230. Specifically, the clamp 2230 can further comprise a lock or screw lock 2420, which can extend through the upright 2240 to engage the upright 2240. As also shown, the positioner arm 2250 can extend in a horizontal direction. More specifically, the positioner arm 2250 can extend from a top end of the upright 2240. The clamp 2230 can comprise a body or clamp body 2530, which can define a clamp slot 645 (shown in FIG. 2) for receiving a rail 605 (shown in FIG. 2) of the table 110. In some aspects, the rail 605 of the table 110 can be configured to slide within the clamp slot 645 to allow the active positioning apparatus 2200 to be repositioned along a length of the table 110 as needed without disassembling any of the parts of the system 200. The clamp 2230 can further comprise a lock or screw lock 2410 and locks or screw locks 2410a,b, which can extend through the clamp body to engage the rail 605. The active positioning apparatus 2200 can comprise a gear or drive element 2214 and a pawl or lock 2216, which can respectively configured to drive and hold movement of the positioner arm 2250, as desired, during use of the patient positioning system 200.

FIGS. 26 and 27 are side views of a positioner arm 2250, a lock 2212, and a drive element 2214 of the active positioning apparatus 2200 of FIG. 24. FIGS. 26 specifically shows the lock 2212 engaged with the positioner arm 2250 and, more specifically, the teeth 715 thereof; while FIG. 27 shows the lock 2212 disengaged from the positioner arm 2250, which has also moved with respect to each of the lock 2212 and the drive element 2214. As shown and described in more detail through the views shown in FIGS. 30A-31B, the drive element 2214 can be selectively engaged with the positioner arm 2250 even as, at least when viewed from the side in FIGS. 26 and 27, the drive element 2214 appears to be in continuous engagement. Shown unassembled to the positioning pad 2220 (shown in FIG. 33), the ball end or distal end can comprise or define a spherical portion defining a radius R2670, which can be configured to be received within a matching recess in the positioning pad 2220.

FIGS. 28 and 29 are perspective views of the active positioning apparatus 2200 of FIG. 24 in varying conditions. FIG. 28 shows the upright 2240 in a raised position with respect to the clamp 2230 of the active positioning apparatus 2200, and FIG. 29 shows the upright 2240 in a lowered position with respect to the clamp 2230 of the active positioning apparatus 2200.

FIGS. 30A-31B are top views of the active positioning apparatus 2200 of FIG. 24 in varying configurations or conditions. More specifically, FIG. 30A is a top view of the active positioning apparatus 2200 of FIG. 24, and FIG. 30B is a detail top view of the active positioning apparatus 2200 of FIG. 24 taken from detail 30B of FIG. 30A showing the drive element 2214 engaged with the positioner arm 2250. As shown, each of the lock 2212 and the drive element 2214 can be aligned with and/or engaged with the notches 715 defined in the positioner arm 2250. The lock 2212 can be aligned with and assembled to a surrounding portion of the adjustment 2210 and, more specifically, the body 2450 along an axis 3502. The drive member 2214 can be aligned with and assembled to a surrounding portion of the adjustment hub 2210 and, more specifically, the body 2450 along an axis 3501, which can be angled at 90 degrees with respect to a longitudinal direction of the positioner arm 2250 and an axis 3001 defined by the positioner arm 2250 and/or the adjustment hub 2210. More specifically, teeth of the drive element 2214 can be aligned with the axis 3001 and the teeth 715 of the positioner arm 2250.

When engaged with the positioner arm 2250, the lock 2212 and, more specifically, an engagement member 2512 thereof can lock or maintain a position of the positioner arm 2250 with respect to the adjustment hub 2210, while an actuating member 2612 of the lock 2212 can facilitate movement (more specifically, rotational movement) of the lock 2212 by a user between engagement and disengagement of the lock 2212. A biasing element 3630, which can be a spring, can bias the lock 2212 towards engagement with the positioner arm 2250 so that, for example, the positioner arm 2250, being configured to keep a patient in a safe position during a procedure, only moves when actively disengaged by a user. As shown, the biasing element 3630 can be a torsion spring.

When engaged with the positioner arm 2250, the drive element 2214 and, more specifically, an engagement member 2514 thereof can adjust or manipulate a linear position of the positioner arm 2250 with respect to the adjustment hub 2210, while an actuating member 2614 of the drive element 2214 can facilitate movement (more specifically, rotational movement) of the drive element 2214 through and during rotation of the drive element 2214. A length of each of the actuating members 2612,2614 can, through leverage, reduce the force required to produce movement in the lock 2212 and the drive element 2214. More specifically, a distance between a pivot point of the lock 2212 (e.g., the axis 3502) or a pivot point of the drive element 2214 (e.g., the axis 3501) and the point on the lock 2212 or drive element 2214 at which a user applies a force (e.g., a point on one of the actuating members 2612,2614) can define a lever distance, and the applied force multipled by the lever distance can represent a torque able to rotate the lock 2212 or the drive element 2214 in one direction or another, which can engage or disengage the lock 2212 or, alternatively, can move the positioner arm 2250 in a linear direction (e.g., towards the patient or further away from the patient).

FIG. 31A is a top view of the active positioning apparatus 2200 of FIG. 24, and FIG. 31B is a detail top view of the active positioning apparatus 2200 of FIG. 24 taken from detail 31B of FIG. 31A showing the drive element 2214 disengaged from the positioner arm 2250. As shown, the teeth of the drive element 2214 and the drive element 2214 as a whole can be offset from and disengaged with the notches 715 defined in the positioner arm 2250 and, more specifically, can be offset in a transverse direction from the axis 3001 (i.e., in a direction angled at 90 degrees with respect to axis 3001). The drive element 2214 can be so configured that, when both the lock 2212 and the drive element 2214 are disengaged with the positioner arm 2250, the positioner arm 2250 is able to move freely with respect to the adjustment hub 2210 by a simple push or pull of any part of the positioner arm 2250 or the pad 2220. More specifically, the adjustment hub 2210 can be configured to allow free travel or movement of the positioner arm 2250 when the lock 2212 and the drive element 2214 are disengaged from the positioner arm 2250; and the adjustment hub 2210 can be configured to allow less or more limited movement of the positioner arm 2250 when the drive element 2214 still engaged with the positioner arm 2250, even with the lock 2212 disengaged, but with the leverage offered by the actuating member 2614.

FIGS. 32-34 and 50 show additional views of the active positioning apparatus 2200. More specifically, FIG. 32 is a side view of the active positioning apparatus 2200 of FIG. 24, FIG. 33 is a sectional side view of the positioner arm 2250 and pad 2220 of the active positioning apparatus 2200 of FIG. 24, and FIG. 34 is a sectional side view of the clamp 2230 of the active positioning apparatus 2200 of FIG. 24. Meanwhile, FIG. 50 is a side view of the active positioning apparatus 2200 of FIG. 24 and mirrors the geometry of FIG. 32. As shown, the pad 2220 can be angled by an rotation angle 3370 with respect to the disclosed default position of the pad 2220, in which a base of the pad 2220 can be angled at 90 degrees with respect to the positioner arm 2250. In some aspects, the rotation angle 3370 can be at least 15 degrees in the direction shown or in the opposite direction and can be in any direction, not just in the view disclosed or in the top or bottom views as well. As shown in FIG. 34, the screw lock 2410 can extend to a slot formed in the body 2430 of the clamp 2230, which can be configured to receive the rail 605 (shown in FIG. 6) of a table 110 (shown in FIG. 6) to which the active positioning apparatus 2200 is attached.

FIGS. 35 and 36 show additional views of the active positioning apparatus 2200. More specifically, FIG. 35 is a partial sectional side view of the active positioning apparatus 2200 of FIG. 24, and FIG. 36 is an exploded side perspective view of the adjustment hub 2210 of the active positioning apparatus 2200 of FIG. 24. Openings defined in the cavity 2458 of the body 2450 of the adjustment hub 2210 can define the respective axes 3501,3502. As shown, the axis 3502 can be further defined by-or the body 2450 can define-a boss to maintain a position of the lock 2212, which as already described can remain aligned with the teeth 715 of the positioner arm 2250 through both engagement and disengagement; while the axis 3501 can be defined by just an opening and not a boss, which can leave space for the drive element 2214 to move away from the teeth 715 of the positioner arm 2250 and thereby disengage from the positioner arm 2250. Again, as shown, the cavity 2458 can face or open upward (away from the clamp 2230) and rearward (away from the pad 2220 when installed) to provide ready access to the lock 2212 and the drive element 2214 by a user (e.g., a surgeon) during a procedure utilizing the active positioning apparatus 2200.

As shown in FIG. 36, the lock 2212 can be assembled to and can rotate about a shaft 3610 and can be assembled to and its positioned biased during operating by the biasing element 3630. The active positioning apparatus 2200 and, more specifically, the adjustment hub 2210 can comprise a spacer or bushing 3620, about which the biasing element 3630 and/or the engagement element 2512 can be assembled, and a fastener 3640 to facilitate assembly of the lock 2212. Meanwhile, the drive element 2214 and, more specifically, the engagement member 2514, can be assembled to and can rotate about a shaft 3660. The active positioning apparatus 2200 and, more specifically, the adjustment hub 2210 can comprise a spacer or bushing 3670, about which the engagement element 2514 can be assembled. Again, as shown, the shape of the cavity 2458, including the absence of any feature such as a boss, can allow sufficient space for the drive element 2214 and, more specifically, the engagement element 2514 to move or shift sideways and out of engagement with the positioner arm 2250 and the teeth 715 thereof.

FIGS. 37-39 show additional views of the active positioning apparatus 2200. More specifically, FIG. 37 is an exploded top perspective view of the clamp 2230 of the active positioning apparatus 2200 of FIG. 24, FIG. 38 is an exploded top perspective view of the positioner arm 2250 and the pad 2220 of the active positioning apparatus 2200 of FIG. 24, and FIG. 39 is an exploded top perspective view of the active positioning apparatus 2200 of FIG. 24. As shown in FIG. 39, the body 2430 of the clamp 2230 can define a groove configured to retain the upright 2240. More specifically, as shown, the groove can define a dovetail shape in cross-section, which can maintain a position of the upright 2240 and allow for movement in just a vertical direction.

In an active positioning apparatus 2200, an adjustment hub 2210 can be configured to dynamically receive an adjustment input during a surgery or other procedure to position the positioning pad 2220 relative to the adjustment hub. The active positioning apparatus 2200 can be configured to apply a force directed away from the adjustment hub and toward a patient. The term “dynamic”, “dynamically”, and grammatical equivalents, as used herein and in reference to aspects of the patient positioner or patient positioning apparatus disclosed, means capable of being selectively moved, adjusted, or re-positioned during pre-operative, intra-operative, or post-operative conditions without disturbing the requirements and conditions necessary to each condition as is known to an ordinarily skilled user of aspects of the present disclosure. In some aspects in which the patient positioner or patient positioning apparatus is configured to dynamically receive an adjustment input “while loaded,” the term can further mean capable of being selectively moved, adjusted, or re-positioned while the patient positioner 220,230 or patient positioning apparatus 2200,2300 or the pad 225,235,2220,2320 thereof is loaded (e.g., by the body of the patient 100). Typically, while loaded, any structure disclosed previously by others cannot be both locked in place, at least within a range of positions, and also adjusted at the same time. Even if, for the sake of argument, such a structure can be positively locked in place, the structure cannot be adjusted while being locked; and even if such structure can be adjusted, the structure cannot be locked in place during that adjustment.

The adjustment input can comprise disengaging a lock or pawl 2212 and advancing or retracting the positioning pad 2220 relative to the adjustment hub via a mechanism disclosed and described herein such as, for example and without limitation, the drive element 2214 and the teeth 715 of the positioner arm 2250. The adjustment input can be provided at the adjustment hub 2210, and in this way the positioning pad 2220 can be dynamically positioned relative to the patient without disturbing coverings, drapes, or sterile fields. This is shown in exemplary embodiments where the patient positioning apparatus is attached to the table 110 and the adjustment hub 2210 is substantially aligned with an edge of the table 110 and need not be positioned within the operation site, draped area, or sterile field. Again, the adjustment hub 2210 can be configured to attach to the table 110 or other structure via the clamp 2230 and optionally vertically positionable via the upright 2240, which can be operably connected between the adjustment hub 2210 and the clamp 2230.

Skipping forward, FIGS. 42-45, 48, and 49 are various views of the passive positioner assembly or passive positioning apparatus or patient positioning apparatus 2300, in accordance with another aspect of the disclosure. More specifically, FIG. 42 is a side view of the passive positioning apparatus 2300, FIG. 43 is an exploded top rear perspective view of the passive positioning apparatus 2300 of FIG. 42, FIG. 44 is an exploded top rear perspective view of an adjustment hub 2310 of the passive positioning apparatus 2300 of FIG. 42, FIG. 45 is a sectional side view of a positioner arm 2350 and a pad 2320 of the passive positioning apparatus 2300 of FIG. 42, FIG. 48 is a rear view of the passive positioning apparatus 2300 of FIG. 42, and FIG. 49 is a top view of the passive positioning apparatus 2300 of FIG. 42.

The passive positioning apparatus 2300 can comprise a clamp 2330. The passive positioning apparatus 2300 can comprise an upright 2340, which can be slideably secured to the clamp 2330 and can have any one or more of the features and functionality of the clamp 2230 (shown in FIG. 24). The passive positioning apparatus 2300 can comprise an adjustment hub 2310. The passive positioning apparatus 2300 can comprise a positioner arm 2350, which can be slideably secured to the adjustment hub 2310. More specifically, the positioner arm 2350 can define a proximal end and a distal end, where the proximal end can be received by the adjustment hub 2310 in inserted relation and the distal end can be attached to the positioning pad 2320. The passive positioning apparatus 2300 can comprise a positioning pad 2320, which can be rotatably secured to the adjustment hub 2310. The adjustment hub 2310 can be configured to position the positioning pad 2320 relative to the adjustment hub 2310. Alternatively, the adjustment hub 2310 can comprise the positioner arm 2350.

The positioning pad 2320 can be configured to be positioned by being pulled away from the adjustment hub 2310. A lock or pawl 2312 can be configured to permit free movement of the positioning pad 2320 away from the adjustment hub, but will engage and lock when a force tends to push the positioning pad 2320 back towards the adjustment hub 2310. The lock or pawl 2312 can be selectively disengaged in order to permit the positioning pad 2320 to retract back toward the adjustment hub 2310. The adjustment hub 2310 can be configured to attach to the table 110 or other structure via a clamp 2330 and can optionally be vertically positionable via an upright 2340, which can be operably connected between the adjustment hub 2310 and the clamp 2330. The adjustment hub 2310 can further comprise a positioner arm 2350, which can define a proximal end and a distal end, where the proximal ends can be received by the adjustment hub 2310 in inserted relation and the distal end can be attached to the positioning pad 2320.

Skipping back, FIGS. 40, 41, 46, and 47 are various views of the patient 100 positioned on the table 110 using the patient positioning system 2000. More specifically, FIGS. 40 and 41 are top views of the patient 100 positioned on the table 110 using the patient positioning system 2000 comprising the active positioning apparatus 2200 of FIG. 24 and respectively showing the patient positioning system 200 before and after adjustment. Similarly, FIGS. 46 and 47 are top perspective views of the patient 100 positioned on the table 110 using the patient positioning system 2000 and comprising the passive positioner assembly 2300 of FIG. 42 showing the patient positioning system 2000 before and after adjustment. Each of FIGS. 40, 41, 46, and 47 illustrate three of the active positioner assemblies 2200 and two of the passive positioner assemblies 2300, each of which can be slidably and/or adjustably mounted to the rail 605 of the table 110, in position against the patient 100. Certain aspects of the disclosure contemplate simultaneous use of multiple positioner assemblies 2200,2300. For example and without limitation, the active positioning apparatus 2200 and the positioning pad 2220 thereof can be configured to apply a force against the patient 100 in a first direction, and the passive positioning apparatus 2300 and the positioning pad 2320 thereof can be configured to abut the patient 100 in an area of the body opposite the active positioning apparatus 2200 to securely hold the patient 100 between the first and second positioning pads 2220,2320.

The system 2000 can comprise a combination of one or more active positioner assemblies 2200 and/or one or more passive positioner assemblies 2300 and/or other elements in various aspects. For example and without limitation, the active positioning apparatus 2200 can be one of a sternal active positioner assembly, a sacral active positioner assembly, or a thigh active positioner assembly; and the passive positioner assembly 2300 can be one of a sternal passive positioner assembly or a thigh active positioner assembly. In some aspects, a patient positioning system 2000 can comprise other patient positioning devices such as, but not limited to, an axillary pad 2001 or a bladder 2002. Again, as shown, the cavity 2458 can face or open upward (away from the clamp 2230) and rearward (away from the pad 2220 when installed) to provide ready access to the lock 2212 and the drive element 2214 by a user (e.g., a surgeon) during a procedure utilizing the active positioner assembly 2200.

A method for preoperative positioning of the patient 100 on the table 110 can comprise one or more of the following steps, in any suitable order (with the caveat that, including with respect to other method steps disclosed herein, any disclosed reference numbers are not intended to limit the disclosed functionality or structures to the referenced):
1. The patient 100 can be lying supine on the table 110 (e.g., an operating room table or a radiologic procedure room table).
2. The patient 100, anesthetized or not, can be rolled to the conventional lateral decubitus position, right or left. (The right lateral decubitus position is illustrated.) The patient 100 can be centered on the table, taking special care to center the decubitus hip and shoulder (the right hip and the right shoulder in the present aspect).
3. The conventional axillary roll 120 can be placed under the patient's decubitus armpit, and the air bladder 215 can be placed under the patient's decubitus flank. If the patient 100 has a known lumbar or thoracolumbar deformity, the air bladder 215 can be positioned at the apex of the known deformity. The air bladder 215 can also be used to prevent coronal sag for patients with wider hips.
4. Starting at the anterior and posterior chest region, the sternal pad 225a can be placed against the sternum and the sternal active positioner assembly 220a can be attached to the table 110.
5. The back pad 235a can be placed against the patient's posterior interscapular spine (e.g., the upper back), and the sternal passive positioner assembly 230a can be attached to the table 110. Effectively, the patient's chest and upper torso can be securely stabilized to the table 110.
6. The sacral pad 225c can be placed against the patient's mid sacrum and the sacral active positioner assembly 220c can be attached to the table 110.
7. The front thigh pad 225b can be placed against the patient's anterior thigh and the thigh active positioner assembly 220b can be attached to the table 110, respectively.
8. The sacral active positioner assembly 220c can be deployed/adjusted to deliver the anteriorly directed force C on the patient's sacrum, and the thigh active positioner assembly 220b can be deployed/adjusted to deliver the posteriorly directed force B on the patient's anterior thigh. This process can extend the patient's hips, anteriorly caudally tilting the pelvis and affectively forcing the lumbar spine into a natural lordosis. This forced lordosis can effectively restore innate lordosis, reduce sagittal plane deformities, and reduce certain fractures of the lumbar spine.
9. The sternal pad 225a and the opposing back pad 235a can be loosened to allow the active sternal positioner assembly 220a to effectively push the patient's upper torso posteriorly (in the direction A) and create greater forced lordosis.
10. Once this upper torso adjustment has been completed, the clamps 240 (or other table attachments) of the sternal active positioner assembly 220a, sternal passive positioner assembly 230a, sacral active positioner assembly 220c, and thigh active positioner assembly 220b can be tightened.
11. Once the desired lordosis has been achieved, the rear thigh pad 235b can be placed against the patient's posterior thigh, and the thigh passive positioner assembly 230b can be attached to the table 110 via the corresponding clamp 240.
12. In some aspects, an optional posterior lumbar active positioner assembly can be applied at this time, or placed later under sterile conditions, against the patient's posterior lumbar spine. This additional active positioner assembly 220 can be adjusted/deployed to direct an anterior force against the patient's posterior lumbar spine to further create lumbar lordosis.
13. The air bladder 215 under the patient's decubitus flank can be filled with air to fill the potential void between the patient's flank and the table 110, or it can be expanded greater than the void area, and in doing so, the air bladder 215 can create a vector of force towards the ceiling that can aid in the reduction of coronal deformities of the lumbar spine or prevent coronal sag as mentioned in step 3 above.

In some aspects, a method of using the various aspects of the disclosed apparatus and systems can comprise, for example and not limitation, a method for preoperative and intraoperative positioning of a patient in a configuration where a patient is lying on a table. More specifically, the method can comprise one or more of the following steps:
1. Adjusting at least one of a sternal passive positioner assembly, a sacral passive positioner assembly, and a thigh passive positioner assembly to contact the patient; and
2. Adjusting at least one of a sternal active positioner assembly, a sacral active positioner assembly, and a thigh active positioner assembly to securely stabilize the patient with respect to the table.

Further embodiments can comprise providing an axillary roll and placing it under the patient's decubitus armpit. More specifically, the method can comprise providing an air bladder and placing it under the patient's decubitus flank. Even more specifically, the method can comprise selectively inflating the air bladder to support or prevent coronal sag.

In other embodiments, a method for preoperative positioning of the patient 100 using the patient positioning system and apparatuses disclosed herein, which can create a forced lordosis in a lateral decubitus position, can comprise one or more of the following steps:
1. Placing the patient 100 on the table 110 in a lateral decubitus position;
2. Providing a sternal active positioner assembly 2200;
3. Attaching the sternal active positioner assembly 2200 to the table 110, proximate to the patient's sternum, via the clamp 2340 of the sternal active positioner assembly 2200;
4. Providing a sternal passive positioner assembly 2300;
5. Attaching the sternal passive positioner assembly 2300 to the table 110, opposite the sternal active positioner assembly 2200, via the clamp 2340 of the sternal passive positioner assembly 2300;
6. Providing the sacral active positioner assembly 2200;
7. Attaching the sacral active positioner assembly 2200 to the table 110, proximal to the patient's mid sacrum, via the claim 2340 of the sacral active positioner assembly 2300;
8. Providing the thigh active positioner assembly 2200;
9. Attaching the thigh active positioner assembly 2200 to the table 110, proximal to the patient's anterior thigh, via the clamp 2240 of the thigh active positioner assembly 2200;
10. Providing the thigh passive positioner assembly 2300;
11. Attaching the thigh passive positioner assembly 2300 to the table 110, opposite the thigh active positione and proximal to the patient's posterior thigh, via the 2340 of the thigh passive positioner assembly 2300;
12. Adjusting the sacral active positioner assembly 2200 to deliver an anteriorly directed force on the patient's sacrum;
13. Adjusting the thigh active positioner assembly 2200 and the thigh passive positioner assembly 2300 to deliver a posteriorly directed force on the patient's anterior thigh; and
14. Adjusting the sternal active positioner assembly 2200 and the sternal passive positioner assembly 2300 to securely stabilize the patient 100 with respect to the table 110.

The method can securely position the patient 100 by forcing the lumbar spine into a forced lordosis, which can effectively restore innate lordosis, reduce sagittal plane deformities, and reduce certain fractures of the lumbar spine. In additional embodiments, the method can comprise providing an axillary roll and placing it under the patient's decubitus armpit. In additional embodiments, the method can comprise providing an air bladder and placing it under the patient's decubitus flank. The air bladder can additionally be selectively inflated to support or prevent coronal sag. In additional embodiments, the method can comprise further adjusting the sternal active positioner assembly in order to effectively push the patient's upper torso posteriorly and create greater forced lordosis.

A method of using the patient positioning system 200,2000 can comprise one or more of the following steps, in any suitable order:
1. Engaging a lock of at least one active positioner assembly (e.g., the active positioner assembly 220,2200), which can comprise lockably maintaining a position of a pad (e.g., the pad 225,235,2220,2320) with respect to an adjustment hub (e.g., the adjustment hub 620,2210,2310); and
2. Dynamically adjusting the at least one active positioner assembly or active positioning apparatus, which can itself comprise one or more of the following steps: disengaging the drive element from a positioner arm (e.g., the positioner arm 410,510,710,2250); positioning the pad close to the patient; engaging the drive element with the positioner arm; and dynamically adjusting, while loaded, a position of the pad by moving the drive element to move the positioner arm; and
3. Maintaining a position of the pad with respect to an adjustment hub 620,2210,2310 by allowing at least moving of the positioner arm towards the patient but not away through a ratcheting structure and operation facilitated by a lock (e.g., the lock 2212) and the biasing element (e.g., the biasing element 3630) thereof, which can engage the lock with the positioner arm without user action.
4. Rotating a handle (e.g., the handle 730) or a drive element (e.g., the drive element 2214) to move the positioner arm in one direction or another.
5. Rotating the lock between engagement and disengagement with the positioner arm.

### Radiographic Study of Forced Lordosis in the Lateral Decubitus Position for Surgical Sagittal Reconstruction

Study Design: Radiographic Study of Healthy Subjects

Objective: This study evaluates the effectiveness of recreating lordosis in the lateral decubitus position using a novel technique of forced lordosis. It compares lumbar lordosis found with conventional surgical positioning techniques currently described for lateral lumbar interbody fusions (LLIF) with lordosis mechanically forced.

Summary of background data: Minimally invasive spine fusion surgery (MIS) techniques continue to grow in popularity. Again, LLIF, OLIF, and XLIF have gained significant popularity in recent years. These surgeries typically involve positioning the patient in the right lateral decubitus position, as this position allows for the safest access to the spine with decreased risk of injury to major vascular structures. Additionally, the lateral position aids in gravity-induced retraction of the peritoneal contents. Furthermore, surgeons can utilize a single position to access the anterior and posterior spine without requiring intraoperative repositioning by operating in a lateral position. The described positioning for LLIF is maintained during surgery by taping the patient to the table with an axillary roll and optional bolster under the right flank. Very little literature exists as to positioning the patient more securely or correcting/reducing spinal deformities or fractures before making an incision or instrumenting the spine. The purpose of this study is to describe a technique that holds the patient in a more secure manner to correct sagittal plane deformities before making an incision. This radiographic study hypothesizes that forced lordosis can restore innate lumbar lordosis better than conventional surgical positioning (without forced lordosis). This study will also present examples of intraoperative results of forced lordosis.

Methods: Healthy individuals ages 21 to 60 were recruited to undergo radiographic imaging of the lumbar spine. Exclusion criteria included skeletal immaturity, pregnancy, history of spinal deformity, previous injury to the lumbar spine that required treatment, or previous spine surgery. Informed consent was obtained from each participant. Patients underwent three different lumbar radiographs: 1) a standing lateral, which served as the patient's baseline lordosis; 2) a lateral view in the right lateral decubitus position; and 3) a lateral view in the right lateral decubitus position with forced lordosis. Forced lordosis was accomplished by extending the hips with a posteriorly directed force on the anterior thigh approximately 4 inches above the superior aspect of the patella, a posteriorly directed force on the lower sternum, and an anteriorly directed counter force at the apex of the sacrum.

Results: Twelve patients (six males and six females) participated in this study, with an average age of 26 years. The average angle of lordosis for standing radiographs was 47.43 degrees. The average angle of lordosis in the unsupported lateral decubitus was 37.70, and the average angle in the forced lordotic position was 45.16. Paired two-tailed t-tests were then used to evaluate the three sets of data. When compared to standing lordosis, the angle of lordosis in an unsupported lateral decubitus position varied significantly (p=0.00017), and the mean of the differences was found to be 9.725 (CI=[5.87, 13.58]). However, positioning the patient in forced lordosis did not result in a significant difference in the angle of lordosis when compared to the angle of standing lordosis (p=0.0894), and the mean of the differences was 2.275 (CI=[−0.413, 4.96]).

Conclusion: The study outcomes show that positioning a patient in an unsupported lateral decubitus position results in decreased lordosis compared to a patient's natural standing position. This relative loss of lordosis can be recovered through forced lordotic positioning. By restoring a patient's lordosis during preoperative positioning, patients have a decreased risk of iatrogenic flat back from spinal fusion surgery, as well as potentially improving the reduction of sagittal plane spinal deformities and the reduction of spinal fractures.

References to Outside Documentation: Numbered parenthetical references below (e.g., “[1]”) correspond to the similarly numbered non-patent literature listed under a section below entitled Bibliography.

### Introduction

Lower back pain and reduced lumbar lordosis are understood to have a strong relationship, especially when comparing patients of similar age [1]. Due to this known relationship, operative fusion of the lumbar spine attempts to restore natural lordosis to maximize outcomes for each patient.

Subsequently, multiple studies have attempted to show which interbody fusion techniques allow for the greatest recreation of segmental lordosis. A meta-analysis by Rothrock et al. compared the correction of segmental lordosis for anterior lumbar interbody fusion (ALIF), lateral lumbar interbody fusion (LLIF), and transforaminal interbody fusion (TLIF) [2]. Each technique demonstrated efficacy in correcting lumbar lordosis. All these techniques corrected lumbar lordosis by less than 5.33°, with TLIF being the highest. Oblique lumbar interbody fusion (OLIF) has more recently been shown to be superior to TLIF in recreating lumbar lordosis [3, 4].

Lateral lumbar interbody fusion (LLIF), extreme lateral interbody fusion (XLIF), and oblique lumbar interbody fusion (OLIF) all utilized the lateral decubitus position for intraoperative positioning. However, almost no literature exists regarding the specifics of how to position the patient in the lateral decubitus position. The benefits of a neutral hip position have been shown to expand the retroperitoneal corridor for OLIF, as demonstrated by Kotheeranurak et al. [5]. Furthermore, the right lateral decubitus position has been suggested to be safer than the left lateral decubitus position as this orientation allows the inferior vena cava and the right common iliac vein to be farther away from the operative intervertebral level [6]. However, outside of the movement of vascular structures and expansion of the corridor, no studies have attempted to propose a positioning technique that would aid sagittal restoration and the recreation of lordosis in this lateral decubitus position.

### Methods

Twelve (12) volunteers (6 males and 6 females) were recruited from families and friends to conduct this research study. Inclusion/exclusion in the study required an age range of 21 to 60 years of age and/or skeletally mature, without a history of spinal deformity or any significant history of lumbar spinal disease. Significant lumbar spinal disease was defined as any previous lumbar condition that required evaluation and/or treatment by a medical doctor or a physical therapist. Female patients were excluded if there was any chance of pregnancy. Informed consent was obtained from each volunteer. Volunteers were paid $50 for their participation.

Each volunteer was required to undergo 3 distinct lateral lumbar radiographs. The first position was with the volunteer standing, considered the volunteers' baseline lordosis. The second position was with the patient in the right lateral decubitus position without any attempt to recreate lumbar lordosis, and this was the standard positioning of typical lateral-based lumbar fusion surgery (FIG. 69). The third position was with the volunteer in the right lateral decubitus position with “forced lordosis.” Forced lordosis was created by and defined as applying a force directed posteriorly at the level of the sternum using a single pad attached to an extension arm that was attached to the x-ray table anterior to the sternum. A second force directed posteriorly was against the anterior aspect of the thighs, utilizing pads on each thigh approximately 3 to 4 inches superior to the patella, and again, the pads were attached to an extension arm and the table. A third force was directed anteriorly to recreate lordosis with a pad/extension arm pushing on the median sacral crest (see FIG. 70).

Each radiograph (standing lateral, right lateral decubitus unforced, and right lateral decubitus forced) was then measured for lumbar lordosis utilizing the inferior endplate of T12 and the inferior endplate of L5. Descriptive statistics were calculated for each positional data set (standing, unforced lateral, and forced lateral), including mean, median, maximum, minimum, range, and standard deviation. Box plots were generated for each data set, and each set was tested for normality using a Shapiro-Wilk test. The results of the Shapiro-Wilk tests are found in Table 1 (FIG. 71). These results show that each data set followed a normal distribution, and therefore, a paired two-tailed t-test was determined to be the optimal test for comparing each data set. Three paired t-tests were then performed to compare the amount of lordosis between each position (standing vs. unforced lateral, forced lateral vs. unforced lateral, standing vs. forced lateral). Following these T-tests, Cohen's D test was used to determine the effect size of position on each subject's angle of lordosis.

### Results

As previously stated, this study involved radiographs of twelve different subjects, six of whom were male and six who were female. The average age of these subjects was 26 years of age. After obtaining proper consent, the three x-rays were taken for each participant. The raw data from these results can be found in the Appendix. The three X-rays were grouped into data sets by their respective positioning (standing, unforced lateral, forced lateral). These data sets were then analyzed for basic descriptive statistics. These results are shown in Table 1 (FIG. 71). After generating these descriptive statistics, each data set was plotted in a boxplot to visually examine the data. The box plots for each data set are found in FIG. 72.

Each data set was also tested for normality via a Shapiro-Wilk Test. The results of these tests are shown in Table 2 (FIG. 73).

Since the p-value for each Shapiro-Wilk test was greater than 0.05, we assumed that each data set followed a normal distribution. Therefore, our test statistic of choice was determined to be Welch's (students) pair T-test as each data set corresponds to one another and is linked by the fact that each subject underwent an x-ray in three different positions. The results of each paired T-test are shown in Table 3 (FIG. 74), including their respective p-values, the mean of the differences, and ninety-five confidence intervals for the means of the differences.

The p-value comparing the angles of lordosis in the standing position versus the forced lateral position did not reach significance when comparing the angles of lordosis in the standing position versus the unforced lateral position. However, the unforced lateral position versus the forced lateral position reached significance. Therefore, one can conclude that the forced lateral position helped recreate each subject's natural lordosis. To further quantify the effect of each position compared to one another, we performed Cohen's D Test, which calculated the effect size of each position compared to the other. The results of this test and its ninety-five percent confidence intervals are shown in Table 4 (FIG. 75).

Due to the results from Cohen's D Test, one can see that when comparing the angles of

lordosis between the standing position (baseline) and the forced lateral position, there is a relatively small effect size between the two angles. In contrast, the effect size of the forced lateral position compared to the unforced lateral position on the angle of lordosis is quite large, as demonstrated by the d estimate of 0.88. Similarly, the effect size between the standing position and the unforced lateral position on the angle of lordosis is also significant, as demonstrated by the d estimate of 1.08.

### Discussion

Sagittal plane reconstruction has been a popular point of discussion for all spine surgery.

As such, a tremendous amount of resources has been dedicated to helping our patients maintain sagittal alignment with the hope that this postural restoration will decrease pain, increase function, and decrease the risk for further degenerative change. When patients are faced with the need for lumbar spinal surgery, procedures that can maximize normal lordosis have found popularity.

Our study demonstrates an easy way to potentially restore normal lordosis with surgical positioning. Although LLIF, XLIF and OLIF all utilize the right lateral decubitus position for surgical positioning, it should be noted that these techniques differ as LLIF and XLIF require a trans-psoas approach to the lumbar spine and OLIF approaches the spine anterior to the psoas. By transversing the psoas muscle, LLIF and XLIF require intraoperative neuromonitoring as this approach passes through the lumbar plexus. Therefore, LLIF and XLIF require that the patient be under light anesthesia and not paralyzed in comparison to OLIF that allows the patient to be fully paralyzed during the procedure. This use of paralytic agents may improve the ability to restore lordosis and reduce deformities. Although this study only investigates the recreation of lordosis in fully awake volunteers in the lateral decubitus position, one can hypothesize that this method of recreating lordosis may be underrepresented as patients who are fully paralyzed may be able to be positioned with greater lordosis due to their lack of muscular tone during positioning.

Two case examples of this technique forced lordosis, and how it affects spinal deformity may help to show the potential power of this positioning technique and its ability to help patients.

Case 1: A 62-year-old female with a grade II L4-5 degenerative spondylolisthesis, a BMI of 42, had developed severe spinal stenosis, and required surgical intervention. Her preoperative films showed advanced degenerative disc disease with significant loss of disc height (FIG. 76), and a spondylolisthesis that showed no translational movement on standing flexion (FIG. 77) and extension (FIG. 78) lateral images. Under general anesthesia intraoperatively forced lordosis was utilized prior to a skin incision, and this technique almost completely reduced her spondylolisthesis and created what appeared to be a much more treatable condition (FIG. 79). Subsequently, the patient underwent oblique lumbar interbody fusion (FIG. 80).

Case 2: A 65-year-old male with a degenerative scoliosis, loss of lordosis, and severe spinal stenosis required surgical intervention. His preoperative radiographic films show the degenerative lumbar scoliosis with lateral listhesis of L1-2, L2-3, and L4-5 (FIG. 81). His standing lateral shows loss of disc height and the loss of lordosis (FIG. 82). Flexion (FIG. 83) and Extension (FIG. 84) lateral views show minimal signs of restoring lordosis and no apparent movement at L4-5. The patient underwent oblique lumbar interbody fusion with intraoperative forced lordosis. Post operative standing lateral (FIG. 85) and AP (FIG. 86) show restoration of sagittal and coronal posture.

### Conclusion

Unforced lateral decubitus positioning for lateral lumbar fusion surgery can lead to a loss of lumbar lordosis. Furthermore, forced lordosis in the lateral decubitus position can restore baseline lordosis. Through forced lordosis iatrogenic flat back syndrome may be decreased. In the presence of sagittal plane deformities or fractures that require surgical intervention, forced lordosis may improve the reduction of the deformity or fracture. Further clinical use should help us understand the potential power of this simple technique.

Appendix: Raw Data is provided in FIG. 87.

### Bibliography

1. Chun SW, Lim CY, Kim K, Hwang J, Chung SG. The relationships between low back pain and lumbar lordosis: a systematic review and meta-analysis. Spine J. 2017;17 (8): 1180-91.
2. Rothrock RJ, McNeill IT, Yaeger K, Oermann EK, Cho SK, Caridi JM. Lumbar Lordosis Correction with Interbody Fusion: Systematic Literature Review and Analysis. World Neurosurg. 2018; 118:21-31.
3. Li J, Chen Y, Wu H, et al. Can oblique lateral interbody fusion (OLIF) create more lumbosacral lordosis in lumbar spine surgery than minimally invasive transforaminal interbody fusion (MIS-TLIF)? Front Surg. 2022;9:1063354.
4. Zhu HF, Fang XQ, Zhao FD, et al. Comparison of Oblique Lateral Interbody Fusion (OLIF) and Minimally Invasive Transforaminal Lumbar Interbody Fusion (MI-TLIF) for Treatment of Lumbar Degeneration Disease: A Prospective Cohort Study. Spine (Phila Pa 1976). 2022;47 (6): E233-e42.
5. Kotheeranurak V, Singhatanadgige W, Ratanakornphan C, Yingsakmongkol W, Hynes RA, Limthongkul W. Neutral hip position for the oblique lumbar interbody fusion (OLIF) approach increases the retroperitoneal oblique corridor. BMC Musculoskelet Disord. 2020;21 (1): 583.
6. Joiner A, Gomez G, Vatsia SK, Ellett T, Pahl D. Location variance of the great vessels while undergoing side-bend positioning changes during lateral interbody fusion. J Craniovertebr Junction Spine. 2023;14 (1): 71-5.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure.

Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What which is claimed is:

1. A patient positioning apparatus comprising:
a pad;
a positioner arm coupled to the pad; and
an adjustment hub coupled to the positioner arm and configured to dynamically receive, while loaded, an adjustment input during a surgery, the adjustment hub further comprising a lock, the lock configured to lockably maintain a position of the positioning pad.

2. The patient positioning apparatus of claim 1, wherein the adjustment hub further comprises a biasing element configured to bias the lock towards engagement with the positioner arm and, without user action, engage the lock with the positioner arm.

3. The patient positioning apparatus of claim 1, wherein the lock comprises one of a pawl and a pin configured to engage with the positioner arm and selectively lock the positioner arm in place relative to the adjustment hub.

4. The patient positioning apparatus of claim 1, further comprising a clamp configured to attach the patient positioning apparatus to a structure in fixed relation to the patient.

5. The patient positioning apparatus of claim 4, wherein the clamp defines a slot configured to receive a rail of the structure.

6. The patient positioning apparatus of claim 4, further comprising an upright connecting the clamp to the adjustment hub.

7. The patient positioning apparatus of claim 6, wherein the upright defines an elongated opening configured to lengthen or shorten a connection between the clamp and the adjustment hub.

8. The patient positioning apparatus of claim 1, where the positioner arm defines a proximal end slideably received by the adjustment hub and a distal end coupled to the positioning pad.

9. The patient positioning apparatus of claim 1, wherein the adjustment hub further comprises a drive element, the drive element configured to adjust, while the pad is loaded, a position of the pad relative to the adjustment hub to support one of an anterior side and a posterior side of a patient.

10. The patient positioning apparatus of claim 9, wherein the drive element is configured to dynamically advance or retract the positioner arm relative to the adjustment hub.

11. The patient positioning apparatus of claim 9, wherein the drive element is configured to selectively move between engagement and disengagement with the positioner arm.

12. The patient positioning apparatus of claim 1, further comprising a rack and pinion.

13. The patient positioning apparatus of claim 1, further comprising a gear configured to engage with a plurality of notches or teeth disposed on the positioner arm.

14. The patient positioning apparatus of claim 1, where the adjustment hub is configured to receive the adjustment input outside of a pre-defined surgical area.

15. A patient positioning system comprising:
an active positioner assembly comprising:
a pad;
a positioner arm coupled to the pad; and
an adjustment hub coupled to the positioner arm and comprising a lock, the lock configured to lockably maintain a position of the positioner arm with respect to the adjustment hub; and
a passive positioner assembly configured to abut the patient opposite the active positioner assembly to securely hold the patient between the passive positioner assembly and the active positioner assembly.

16. The patient positioning system of claim 15, wherein the adjustment hub further comprises a drive element, the drive element configured to adjust, while the pad is loaded, a position of the positioning pad relative to the adjustment hub.

17. The patient positioning system of claim 15, wherein the active positioner assembly is one of a sternal active positioner assembly, a sacral active positioner assembly, and a thigh active positioner assembly.

18. The patient positioning system of claim 15, wherein the passive positioner assembly is one of a sternal passive positioner assembly and a thigh active positioner assembly.

19. The patient positioning system of claim 15, further comprising an inflatable bladder.

20. A method for preoperative and intraoperative positioning of a patient, the method comprising:
adjusting at least one passive positioner assembly to contact the patient, the patient lying on a table; and
dynamically adjusting at least one active positioner assembly to securely stabilize the patient with respect to the table.

21. The method of claim 20, wherein:
the passive positioner assembly is one of a sternal passive positioner assembly, a sacral passive positioner assembly, and a thigh passive positioner assembly; and
the active positioner assembly is one of a sternal active positioner assembly, a sacral active positioner assembly, and a thigh active positioner assembly.

22. The method of claim 20, further comprising engaging a lock of the at least one active positioner assembly, engaging the lock comprising lockably maintaining a position of a positioning pad of the at least one active positioner assembly with respect to an adjustment hub of the at least one active positioner assembly.

23. The method of claim 20, wherein the at least one active positioner assembly comprises:
a pad;
a positioner arm coupled to the pad; and
an adjustment hub coupled to the positioner arm and comprising a lock and a drive element;
dynamically adjusting the at least one active positioner assembly comprising:
disengaging the drive element from the positioner arm;
positioning the pad close to the patient;
engaging the drive element with the positioner arm; and
dynamically adjusting, while loaded, a position of the pad by moving the drive element to move the positioner arm.

24. The method of claim 20, further comprising placing an axillary roll under the patient's decubitus armpit.

25. The method of claim 20, further comprising:
placing an inflatable bladder under the patient's decubitus flank; and
selectively inflating the bladder.
